(19) United States
(12) Patent Application Publication
(10) Pub. No.: US 2026/0199787 A1
(43) Pub. Date: Jul. 16, 2026

(54) VIRTUAL OBJECT CONTROL METHOD AND APPARATUS, STORAGE MEDIUM, AND ELECTRONIC DEVICE

(71) Applicant: Tencent Technology (Shenzhen) Company Limited, Shenzhen (CN)

(72) Inventor: Zhuocheng ZOU, Shenzhen (CN)

(21) Appl. No.: 19/565,097

(22) Filed: Mar. 12, 2026

Related U.S. Application Data
(63) Continuation of application No. PCT/CN2025/070515, filed on Jan. 3, 2025.

(30) Foreign Application Priority Data
Jan. 30, 2024 (CN) 202410137691.3

(51) Int. Cl. A63F 13/58; A63F 13/56; A63F 13/837

(52) U.S. Cl. CPC A63F 13/58; A63F 13/56; A63F 13/837

(57) ABSTRACT

This application discloses a virtual object control method performed by an electronic device. The method includes: displaying a target virtual role that interacts with a current virtual role in a virtual scene; displaying, when an interactive operation triggered by the current virtual role meets an interaction condition, at least one virtual object at an interaction key location associated with the interactive operation in the virtual scene; controlling, when a target virtual object of the at least one virtual object is in an activated state, the target virtual object in response to a control operation on the target virtual object to move according to a moving track indicated by the control operation; and updating a role status of the target virtual role in response to hitting the target virtual role by the target virtual object.

### CROSS-REFERENCE TO RELATED APPLICATIONS

This application is a continuation application of PCT Patent Application No. PCT/CN2025/070515, entitled “VIRTUAL OBJECT CONTROL METHOD AND APPARATUS, STORAGE MEDIUM, AND ELECTRONIC DEVICE” filed on January 3, 2025, which claims priority to Chinese Patent Application No. 202410137691.3, entitled "VIRTUAL OBJECT CONTROL METHOD AND APPARATUS, STORAGE MEDIUM, AND ELECTRONIC DEVICE" filed with the China National Intellectual Property Administration on January 30, 2024, all of which are incorporated herein by reference in their entirety.

### FIELD OF THE TECHNOLOGY

This application relates to the computer field, and specifically, to a virtual object control technology.

### BACKGROUND OF THE DISCLOSURE

In a current virtual scene, generally, there are a plurality of virtual roles in different camps, which represent different types of identities and each have different skills. A user may implement fighting modes such as a close attack, a remote attack, and a control attack by controlling a virtual object. Specifically, a virtual role controls a virtual object to release a skill once, and a skill prop disappears after reaching a farthest distance or hitting another virtual role, that is, the virtual role completes control on the virtual object.

Therefore, in a game in a related technology, a process in which a virtual role controls a virtual object to complete an interactive operation is usually as follows: First, a player selects a corresponding skill in the game, and triggers the skill for use; then, the role starts to make a corresponding preparing action, and the role releases the skill; finally, a game system performs hit determining, to determine whether the skill successfully hits a target. If the skill hits the target, the game system performs damage calculation according to a skill attribute and a target attribute, to determine an amount of damage caused, and completes a control operation. The foregoing process has a single control operation on the virtual object, and limits the control operation on the virtual object, affecting experience of the user in controlling the virtual object and in a battle process. That is, a virtual scene control mechanism in the related technology has a technical problem that a virtual object control method is single.

For the foregoing problem, no effective solution has been provided yet.

### SUMMARY

Embodiments of this application provide a virtual object control method and apparatus, a storage medium, and an electronic device, to at least solve a technical problem that a virtual object control method in a related method is single.

According to one aspect of the embodiments of this application, a virtual object control method is performed by an electronic device, and the method includes: displaying, in a virtual scene, a target virtual role that interacts with a current virtual role; displaying, when an interactive operation triggered by the current virtual role meets an interaction condition, at least one virtual object at an interaction key location associated with the interactive operation in the virtual scene; controlling, when a target virtual object of the at least one virtual object is in an activated state, the target virtual object in response to a control operation on the target virtual object to move according to a moving track indicated by the control operation; and updating a role status of the target virtual role in response to hitting the target virtual role by the target virtual object.

According to still another aspect of the embodiments of this application, a non-transitory computer-readable storage medium is further provided. The computer-readable storage medium has a computer program stored therein. The computer program is configured for performing, when executed, the foregoing virtual object control method.

According to still another aspect of the embodiments of this application, an electronic device is further provided, including a memory and a processor. The memory has a computer program stored therein. The processor is configured to perform the foregoing virtual object control method by using the computer program.

In the embodiments of this application, the target virtual role interacting with the current virtual role is displayed in the virtual scene, an interactive operation in one phase is triggered by the current virtual role first, and when the interactive operation triggered by the current virtual role meets the interaction condition, at least one virtual object is displayed at the interaction key location associated with the interactive operation in the virtual scene. The at least one virtual object is a new controllable virtual object, to perform triggering in a next phase. When a target virtual object of the at least one virtual object is in an activated state, in response to a control operation on the target virtual object, the target virtual object is controlled to move according to a moving track indicated by the control operation. When the target virtual object hits a target virtual role, a role status of the target virtual role is updated in response to hitting the target virtual role by the target virtual object, thereby implementing an interactive operation between virtual roles by using a controllable virtual object. This application provides a virtual object control method, that is, when an interactive operation triggered by a current virtual role meets an interaction condition and a target virtual object of at least one virtual object is in an activated state, the target virtual object is controlled, so that a new control method, that is, a two-phase trigger manner, is configured for controlling a virtual object, and a technical problem that a virtual object control method is single in a virtual scene control mechanism in the related technology is solved.

### BRIEF DESCRIPTION OF THE DRAWINGS

The accompanying drawings described herein are configured for providing a further understanding of this application, and form part of this application. Exemplary embodiments of this application and descriptions thereof are configured for explaining this application, and do not constitute any inappropriate limitation to this application. In the accompanying drawings:

FIG. 1 is a schematic diagram of a hardware environment of an exemplary virtual object control method according to an embodiment of this application.

FIG. 2 is a flowchart of an exemplary virtual object control method according to an embodiment of this application.

FIG. 3 is a schematic diagram of an exemplary virtual object control method according to an embodiment of this application.

FIG. 4 is a schematic diagram of another exemplary virtual object control method according to an embodiment of this application.

FIG. 5 is a schematic diagram of still another exemplary virtual object control method according to an embodiment of this application.

FIG. 6 is a schematic diagram of still another exemplary virtual object control method according to an embodiment of this application.

FIG. 7 is a schematic diagram of still another exemplary virtual object control method according to an embodiment of this application.

FIG. 8 is a schematic diagram of an exemplary virtual object display method according to an embodiment of this application.

FIG. 9 is a schematic diagram of another exemplary virtual object display method according to an embodiment of this application.

FIG. 10 is a schematic diagram of still another exemplary virtual object display method according to an embodiment of this application.

FIG. 11 is a schematic diagram of still another exemplary virtual object control method according to an embodiment of this application.

FIG. 12 is a schematic diagram of still another exemplary virtual object control method according to an embodiment of this application.

FIG. 13 is a schematic diagram of still another exemplary virtual object control method according to an embodiment of this application.

FIG. 14 is a schematic diagram of still another exemplary virtual object control method according to an embodiment of this application.

FIG. 15 is a schematic diagram of still another exemplary virtual object control method according to an embodiment of this application.

FIG. 16 is a schematic diagram of still another exemplary virtual object control method according to an embodiment of this application.

FIG. 17 is a flowchart of another exemplary virtual object control method according to an embodiment of this application.

FIG. 18 is a flowchart of still another exemplary virtual object control method according to an embodiment of this application.

FIG. 19 is a schematic diagram of still another exemplary virtual object control method according to an embodiment of this application.

FIG. 20 is a schematic diagram of still another exemplary virtual object control method according to an embodiment of this application.

FIG. 21 is a schematic diagram of still another exemplary virtual object control method according to an embodiment of this application.

FIG. 22 is a schematic diagram of still another exemplary virtual object control method according to an embodiment of this application.

FIG. 23 is a schematic diagram of still another exemplary virtual object control method according to an embodiment of this application.

FIG. 24 is a schematic diagram of still another exemplary virtual object control method according to an embodiment of this application.

FIG. 25 is a schematic diagram of still another exemplary virtual object control method according to an embodiment of this application.

FIG. 26 is a schematic diagram of still another exemplary virtual object control method according to an embodiment of this application.

FIG. 27 is a schematic structural diagram of an exemplary virtual object control apparatus according to an embodiment of this application.

FIG. 28 is a schematic structural diagram of an exemplary electronic device according to an embodiment of this application.

### DESCRIPTION OF EMBODIMENTS

In order to make persons skilled in the art better understand the solutions of this application, the following clearly and completely describes the technical solutions in the embodiments of this application with reference to the accompanying drawings in the embodiments of this application. Apparently, the described embodiments are only some of the embodiments of this application rather than all of the embodiments. All other embodiments obtained by a person of ordinary skill in the art based on the embodiments of this application without creative efforts shall fall within the protection scope of this application.

In the specification, claims, and accompanying drawings of this application, the terms "first", "second", and the like are intended to distinguish between similar objects rather than describe a specific order or sequence. The terms used in such a way are interchangeable in a proper circumstance, so that the embodiments of this application described herein can be implemented in orders except the order illustrated or described herein. Moreover, the terms "include", "contain" and any other variants mean to cover the non-exclusive inclusion. For example, a process, method, system, product, or device that includes a list of operations or units is not necessarily limited to those operations or units, but may include other operations or units not expressly listed or inherent to such a process, method, product, or device.

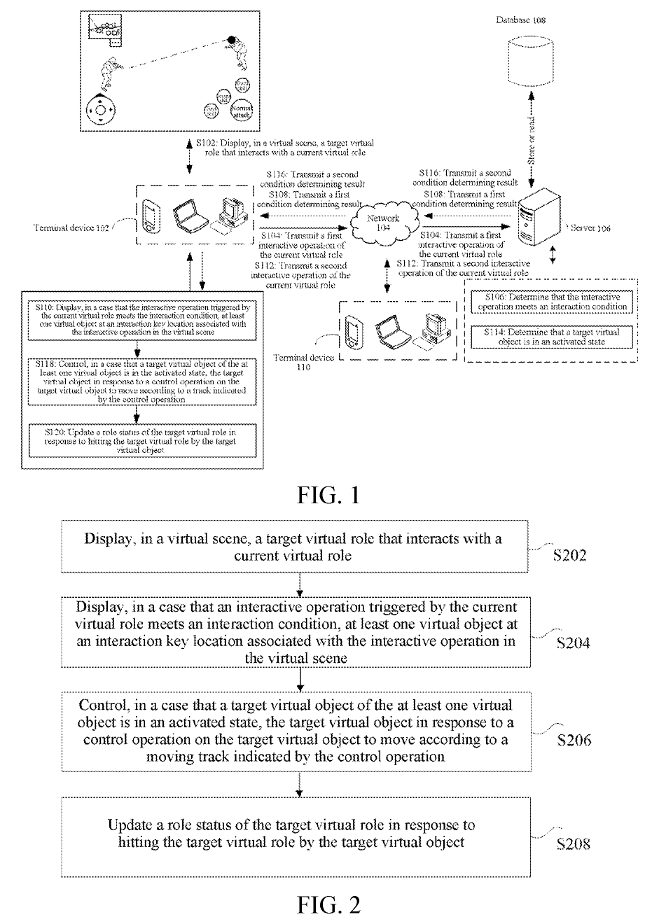

According to one aspect of an embodiment of this application, a virtual object control method is provided. As an exemplary implementation, the foregoing virtual object control method may be applied to, but is not limited to, a virtual object control system in a hardware environment shown in FIG. 1. The virtual object control system may include, but is not limited to, a terminal device 102, a network 104, a server 106, a database 108, and a terminal device 110. A target client runs in the terminal device 102 and the terminal device 110 separately (as shown in FIG. 1, an example in which the target client is a game application client is used). The terminal device 102 and the terminal device 110 separately include a human-computer interaction screen, a processor, and a memory. The human-computer interaction screen is configured to display a virtual game scene (the virtual game scene shown in FIG. 1), and is further configured to provide a human-computer interaction interface to receive a human-computer interaction operation for controlling a virtual object controlled in a virtual scene, where the virtual object completes a game task set in the virtual scene. The processor is configured to generate an interaction instruction in response to the human-computer interaction operation, and transmit the interaction instruction to the server. The memory is configured to store related attribute data, such as object attribute information of the controlled virtual object and attribute information of a held virtual prop. The attribute information herein may include, but is not limited to, information for identifying an identity and a current location of the virtual prop. The terminal device 102 runs a client that controls a current virtual role. In some embodiments, when a target virtual role is a virtual role controlled by the terminal device, the terminal device 110 runs a client of the target virtual role. The current virtual role and the target virtual role herein may be controlled to perform a specific interactive event in a game, for example, an attack event, a defense event, and a skill release event.

Furthermore, the server 106 includes a processing engine. The processing engine is configured to perform a storing or reading operation on the database 108. Specifically, the processing engine reads, from the database 108, virtual scene information of each virtual object and operation information executed by the virtual object. It is assumed that the terminal device 102 in FIG. 1 is configured to control a current virtual role, and the terminal device 110 is configured to control a target virtual role in the same game task. A specific process of this embodiment includes the following operations: for example, S102 to S108: Display, in a virtual scene, a target virtual role interacting with a current virtual role. A terminal device transmits a first interactive operation of the current virtual role to a server; determines that the interactive operation (for example, the first interactive operation) meets an interaction condition; and the server transmits a first condition determining result to the terminal device. There may be one or more target virtual roles. In addition, the target virtual role may be, but is not limited to, a role (that is, a role attacked by the current virtual role) in a battle team (camp) against the current virtual role in the virtual scene, a role (that is, a role protected by the current virtual role) belonging to the same battle team (camp) as the current virtual role in the virtual scene, or an object having a defense function (such as a defense tower, a super soldier, or a wild monster) in the virtual scene.

Then, for example, S110 and S120: The interactive operation of the current virtual role meets the interaction condition. Display, when an interactive operation triggered by the current virtual role meets the interaction condition, at least one virtual object at an interaction key location associated with the interactive operation in the virtual scene. The terminal device transmits a second interactive operation of the current virtual role to the server; and determines that a target virtual object is in an activated state. The server transmits a second condition determining result to the terminal device. When a target virtual object of the at least one virtual object is in the activated state, in response to a control operation of the target virtual object, control the target virtual object to move according to a track indicated by the control operation. In response to hitting the target virtual role by the target virtual object, update a role status of the target virtual role to cause impact. The interaction condition may be, but is not limited to, that a quantity of taps meets a preset threshold, a tap time meets a preset threshold, a longest distance is reached, a skill is selected, a quantity of times of skill release, skill release is ended, skill release implements hitting, skills respectively released by the current virtual role and the target virtual role "colliding with each other" happens, a quantity of target virtual objects hit by skill release of the current virtual object meets a preset threshold, a role status of the target virtual object is changed (for example, a damage state, a life state, or a defense state of the target virtual role is less than or greater than a preset threshold), and the like. In another exemplary implementation, when the terminal device 102 or the terminal device 110 has a relatively strong computing processing capability, S106 and S114 may alternatively be completed by the terminal device 102 or the terminal device 110. This description is merely an example. This is not limited in any way in this embodiment.

In some embodiments, in this embodiment, the terminal device may be a terminal device on which a target client is configured, and may include but is not limited to at least one of the following: a mobile phone (such as an Android mobile phone or an iOS mobile phone), a notebook computer, a tablet computer, a palmtop computer, a mobile Internet device (MID), a PAD, a desktop computer, or a smart TV. The target client may be a client that supports providing a shooting game task, such as a video client, an instant messaging client, a browser client, or an education client. The network may include, but is not limited to, a wired network and a wireless network. The wired network includes a local area network, a metropolitan area network, and a wide area network. The wireless network includes Bluetooth, Wi-Fi, and other networks implementing wireless communication. The server may be a single server, a server cluster including a plurality of servers, or a cloud server. The foregoing description is merely an example. This is not limited in any way in this embodiment.

In some embodiments, in this embodiment, the foregoing virtual object control method may be, but is not limited to, applied to a game terminal application (APP) that completes a specified combat game task in a virtual scene, for example, a virtual combat game application in a multiplayer online battle arena (MOBA) application. The combat game task may be but is not limited to a game task that is performed by a current player by controlling a virtual object in a virtual scene through human-computer interaction with a virtual object controlled by another player through combat interaction. The foregoing virtual object control method may be further applied to a terminal application such as a multiplayer online role-playing game (MMORPG). In this type of game, a current player may complete a social game task in a game in a role play manner from a first perspective of a virtual object, for example, perform a game task together with another virtual object. The social game task herein may be but is not limited to running in an application (for example, a game APP not running independently) in a form of a plug-in or a mini program, or running in an application (for example, a game APP running independently) in a game engine. The type of the game application may include but is not limited to at least one of the following: a two-dimensional (2D) game application, a three-dimensional (3D) game application, a virtual reality (VR) game application, an augmented reality (AR) game application, or a mixed reality (MR) game application. The foregoing description is merely an example. This is not limited in any way in this embodiment.

The foregoing implementations of this application may be further but are not limited to being applied to a game of an open world type. The so-called open world means that a combat scene in a game is completely free and open, a player may freely advance in any direction, and a distance between boundaries of all directions is very large. In addition, there are simulation objects of various shapes and sizes in the scene, and various types of physical collision or interaction can be generated with entities such as a player and artificial intelligence (AI). In the open world game, the player may control a game task completed by a virtual object through adversarial interaction.

This embodiment of this application includes: displaying, in a virtual scene, a target virtual role that interacts with a current virtual role; displaying, when an interactive operation triggered by the current virtual role meets an interaction condition, at least one virtual object at an interaction key location associated with the interactive operation in the virtual scene; controlling, when a target virtual object of the at least one virtual object is in an activated state, the target virtual object in response to a control operation on the target virtual object to move according to a moving track indicated by the control operation; and updating a role status of the target virtual role in response to hitting the target virtual role by the target virtual object. Therefore, a virtual object control method is provided, that is, when an interactive operation triggered by a current virtual role meets an interaction condition and a target virtual object of at least one virtual object is in an activated state, the target virtual object is controlled, so that a new control method is configured for controlling a virtual object.

In the foregoing implementation, the target virtual object is determined to be in the activated state in the virtual scene when the interactive operation triggered by the current virtual role meets the interaction condition, so that the control operation is performed on the target virtual object, thereby affecting the role status of the target virtual role. On one hand, different control methods may enable a player to select a manner suitable for the player to operate the virtual scene, increasing playability and fun of a game, and enabling the player to have more choices and challenges in the virtual scene. On the other hand, different control methods may enable a player to select an operation manner according to a preference and a habit of the player, thereby increasing adaptability and flexibility of the virtual scene, making the player have more operation space and possibilities, and increasing depth and strategy of the game. Further, the foregoing implementation provides a brand new virtual object control method, solving a technical problem that an existing virtual scene control mechanism has a single virtual object control method.

In an implementation, as shown in FIG. 2, the virtual object control method includes the following operations:

S202: Display, in a virtual scene, a target virtual role that interacts with a current virtual role.

S204: Display, when an interactive operation triggered by the current virtual role meets an interaction condition, at least one virtual object at an interaction key location associated with the interactive operation in the virtual scene.

S206: Control, when a target virtual object of the at least one virtual object is in an activated state, the target virtual object in response to a control operation on the target virtual object to move according to a moving track indicated by the control operation.

S208: Update a role status of the target virtual role in response to hitting the target virtual role by the target virtual object.

In the foregoing implementation, the virtual scene may be configured for indicating a game scenario displayed on an interface when a current user logs in to a game application. When the virtual scene is a battle interface of the game application, a player may select any virtual role as the current virtual role controlled by the player in the virtual scene, and the virtual role currently controlled by the player is the current virtual role. In addition, a plurality of functional modules may be further displayed in the virtual scene, for example, the functional modules may include, but are not limited to, a map module, a task module, and a setting module, for example, the map module is selected to view virtual role distribution on a site, and the task module is selected to collect daily game challenge tasks. The foregoing descriptions of the virtual scene are merely exemplary descriptions, and do not limit a type of the virtual scene in a specific implementation and content included in the virtual scene.

The target virtual role is a virtual role interacting with the current virtual role controlled by the current user, and a quantity of target virtual roles may be one or more. In this implementation, the quantity of target virtual roles is not limited. In addition, the target virtual role may be, but is not limited to, a role (that is, a role attacked by the current virtual role) in a battle team (camp) against the current virtual role in the virtual scene, a role (that is, a role protected by the current virtual role) belonging to the same battle team (camp) as the current virtual role in the virtual scene, or an object having a defense function (such as a defense tower, a super soldier, or a wild monster) in the virtual scene. In this implementation, types of the current virtual role and the target virtual role are not limited.

In addition, a role form displayed in the virtual scene may include, but is not limited to, a role form that can provide an interaction control operation with a player account, for example, may be an animal or a plant form, and a corresponding role feedback may be displayed in response to a trigger operation of the player account. Specifically, when the target virtual role is a small animal, for example, a virtual puppy, in response to a tap operation triggered on the small animal, a jumping action of the virtual puppy may be displayed in the virtual scene. When the target virtual role is a virtual plant, for example, a virtual flower, in response to a tap operation triggered on the virtual flower, a form in which the virtual flower blooms may be displayed in the virtual scene. When the target virtual role is a character role in a game battle, an animation form (such as an appearance picture, a skill release picture, or a virtual role skin) of the virtual role may be displayed in the virtual scene.

In S204, the operation type of the interactive operation triggered by the current virtual role may include, but is not limited to, a tap operation, a double tap operation, a touch and hold operation, a slide operation, a skill release operation (such as an attack operation or a defense operation), or the like. A type of an operation effect of the interactive operation may correspond to a role type of the target virtual role. For example, when the target virtual role and the current virtual role belong to the same camp or battle team, the interactive operation triggered by the current virtual role may be a virtual treatment operation or a virtual recovery operation on the target virtual object. When the target virtual role and the current virtual role belong to different camps or battle teams, the interactive operation triggered by the current virtual role may be a virtual attack operation or a virtual dizziness operation on the target virtual object.

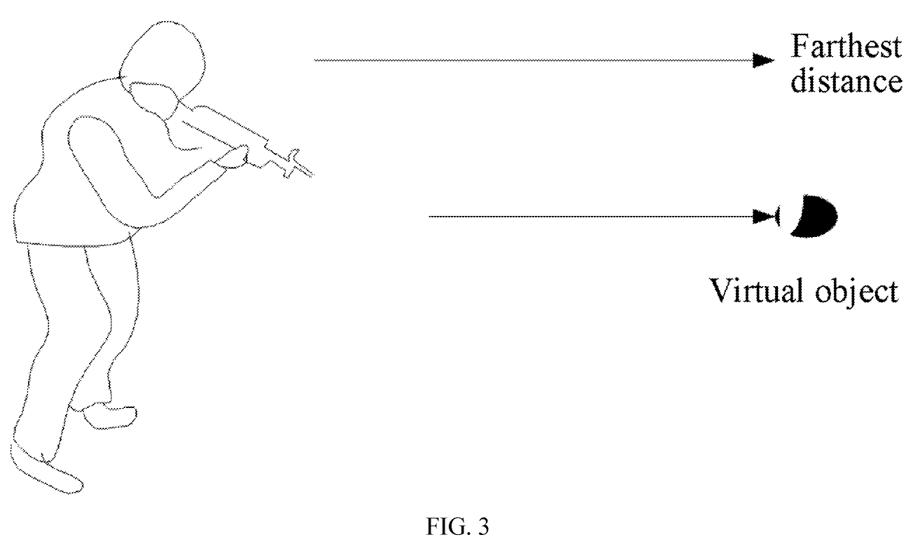

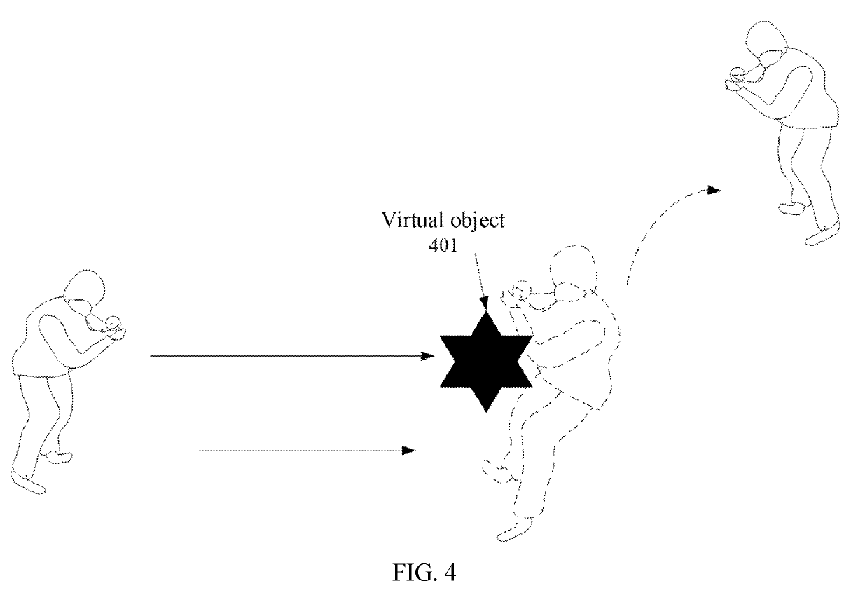

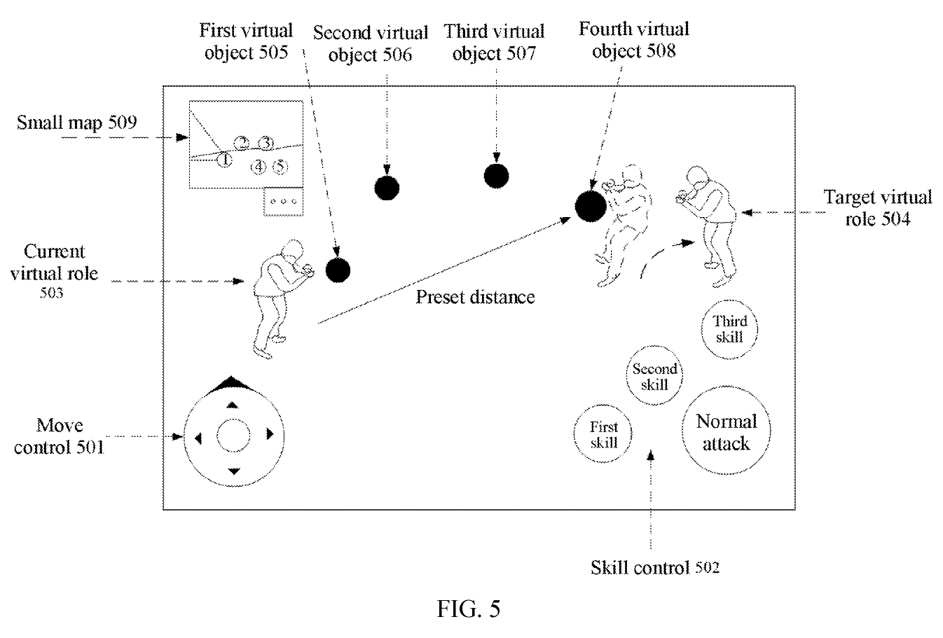

The interaction condition may be a condition that a next stage can be entered to trigger the virtual object to perform interaction. The interaction condition may be, but is not limited to, reaching a farthest distance, selecting a skill, a quantity of times of skill release, ending of skill release, hitting by skill release, "collision" occurs between skills released by the current virtual role and the target virtual role, a quantity of target virtual objects hit by skill release of the current virtual object meets a preset threshold, a role status of the target virtual object changes (for example, a damage state, a life state, or a defense state of the target virtual role is less than or greater than a preset threshold), or the like. In an implementation, at a location at which a skill reaches a farthest distance shown in FIG. 3, the effect is that an ink blob (the virtual object) gradually becomes hidden, or as shown in FIG. 4, a skill released by the current virtual role hits a virtual role, the virtual role is "knocked back", and at least one virtual object 401 is displayed at a knockback location.

The interaction key location associated with the interactive operation may be a location having important impact or a key function in the interactive process, and may be, but is not limited to, an end location of the interactive operation (for example, a hit location of skill release, an end location of skill release time, a location at which a skill reaches a farthest distance, and a location at which a release skill is interrupted), a location on a moving track of the target virtual role (for example, a location may be actively or randomly selected on the track as the interaction key location associated with the interactive operation), a location at which skills respectively released by the current virtual role and the target virtual role "collide", or the like, which is not specifically limited herein.

In a case, the virtual object may be a virtual role having a role form (for example, a controllable life entity or a summoned creature) similar to that of the current virtual role. Specifically, if the virtual object is a virtual summoned creature, the current virtual role may have a virtual teacher-student relationship with the summoned creature (the virtual object), and the current virtual role may control the summoned creature, to release a skill on the target virtual role, or the virtual role automatically follows the target virtual role to release a skill. In another case, the virtual object may alternatively be a prop (such as a dagger, an armor, or a combat boot) having a particular function in the virtual scene. When the target virtual role is in an enemy camp, the virtual object is a prop outputting damage to the target virtual role. When the target virtual object is in an ally camp, the virtual object is a prop having an auxiliary function to the target virtual role. The virtual object may further perform transformation according to fighting situations on a site (for example, automatically attacking an enemy camp or healing its own camp). The virtual object may provide a plurality of types of auxiliary skills, which include, but are not limited to, an auxiliary protection skill, an auxiliary attack skill, an auxiliary viewing skill, an auxiliary resource collection skill, and the like. Specifically, the virtual object may be configured with an auxiliary protection skill, to generate an auxiliary area for the current virtual role by using the virtual object when a health point parameter, a defense value parameter, or a damage value parameter of the current virtual role is less than a preset threshold, so as to protect the current virtual object. For example, when a quantity of enemies within a particular scope of the current virtual role is greater than the preset threshold or the health point of the current virtual role is less than the preset threshold, a virtual beast having a defense function is triggered, and the virtual beast is distributed around the current virtual role to form an auxiliary area. In the auxiliary area, the current virtual role may not be attacked by an enemy to heal or output damage to the enemy, or may continuously damage a target virtual role of an enemy camp when a health point parameter, a defense value parameter, or a damage value parameter of the target virtual role is less than a preset threshold. In this implementation, a specific form and function of the virtual object are not limited.

The displaying at least one virtual object at an interaction key location associated with the interactive operation in the virtual scene may include but is not limited to: displaying one virtual object or a plurality of virtual objects at the interaction key location associated with the interactive operation in the virtual scene after each interactive operation, or selecting or automatically displaying at least one virtual object at a location at which the last interactive operation is completed when a quantity of interactive operations reaches a particular quantity of times or particular interactive damage reaches a particular threshold. This is not specifically limited herein.

The displaying, when an interactive operation triggered by the current virtual role meets an interaction condition, at least one virtual object at an interaction key location associated with the interactive operation in the virtual scene may be specifically: after a quantity of props released by a common skill of the current virtual role meets a preset threshold, displaying an upgraded prop at a location at which the prop is moved by a farthest distance in each skill release process, which is merely an example herein.

In S206, the target virtual object may be determined according to, but is not limited to, a generation order of virtual objects. For example, the first generated virtual object is determined as the target virtual object, or the last generated virtual object is determined as the target virtual object. The target virtual object may further be determined according to a distance between the virtual object and the virtual role. In a current implementation, the virtual role may be the current virtual role, or may be the target virtual role. For example, a virtual object closest to a location of the target virtual role is used as the target virtual object, or a virtual object farthest from the location of the current virtual role is used as the target virtual object. This is not specifically limited herein.

A manner of determining that the foregoing activated state is met may be but is not limited to: when a quantity of virtual objects displayed at the interaction key location associated with the interactive operation is greater than a particular threshold, determining that the target virtual object is in the activated state; or when health point data of the target virtual role is higher than or lower than a particular threshold, determining that the target virtual object is in the activated state. For another example, when the health point data of the current virtual role is higher than or lower than a particular threshold, it is determined that the target virtual object is in the activated state. When the location of the current virtual role in the virtual scene and the location of the target virtual role in the virtual scene are less than a preset range, it is determined that the target virtual object is in the activated state. This is not specifically limited herein.

When the target virtual object in the at least one virtual object is in the activated state, a control operation on the target virtual object may be responded to. The control operation includes, but is not limited to, an operation such as attack or damage performed by the target virtual object on the target virtual role when the target virtual role and the current virtual role belong to different camps, including a path, a direction, a release start location, a release end location, and the like of the attack or the damage, or an operation such as treatment or recovery performed by the target virtual object on the target virtual role when the target virtual role and the current virtual role belong to the same camps, including a path, a direction, a location, a release start location, a release end location, and the like of an operation such as treatment or recovery. This is not specifically limited.

The controlling the target virtual object to move according to the track indicated by the control operation may be but is not limited to: the player selects several moving tracks preset by a system, so that the target virtual object moves according to a preset track. Alternatively, a direction may be selected from a direction control at any angle, and a moving track moving in the direction is formed in the direction, so that the target virtual object moves according to the moving track selected from the direction control. A movement control may also be used in real time, so that the target virtual object moves in real time according to an operation direction of the player on the movement control. This is not specifically limited herein.

An application interface is described below by using FIG. 5. In this implementation, in response to a trigger operation on a skill control 502, a current virtual role 503 may be controlled to release a second skill to a target virtual role 504, and after the second skill hits the target virtual role, a virtual object may be displayed at a corresponding location in a virtual scene. As shown in FIG. 5, a first virtual object 505 is displayed after the second skill hits the target virtual role for the first time, a second virtual object 506 is displayed after the second skill hits the target virtual role for the second time, and a third virtual object 507 is displayed after the second skill hits the target virtual role for the third time. When the current virtual role 503 releases the second skill and hits the target virtual role 504 within a range of the second skill (that is, a preset distance), a fourth virtual object 508 may be displayed at a location in the virtual scene at which the target virtual role is hit by the skill. The first virtual object 505, the second virtual object 506, the third virtual object 507, and the fourth virtual object 508 are forms (styles) of virtual objects displayed in the virtual scene after the first virtual object 505, the second virtual object 506, the third virtual object 507, and the fourth virtual object 508 hit the target virtual role. When the virtual task in this application is a virtual game task of a multiplayer confrontation type, as shown in FIG. 5, a location of each virtual role in a current virtual scene on a game map and an ID corresponding to each virtual role may be displayed in an upper-left window (a small map 509). Herein, a role identifier of each virtual role is indicated by a number. Virtual roles in the game other than the current virtual role and the target virtual role may be displayed, or all virtual roles including the current virtual role and the target virtual role may be displayed. When the virtual task in this application is a virtual game task in which a plurality of virtual roles fight against each other in pairs, in a manner, a role identifier of each virtual role in a prepared state may be displayed by using the small map 509. In another manner, an object account may select a plurality of candidate virtual roles for confrontation between the virtual roles, so that the role identifier of each candidate virtual role can be displayed on the small map 509. In this implementation, the display function of the small map 509 is merely an exemplary description.

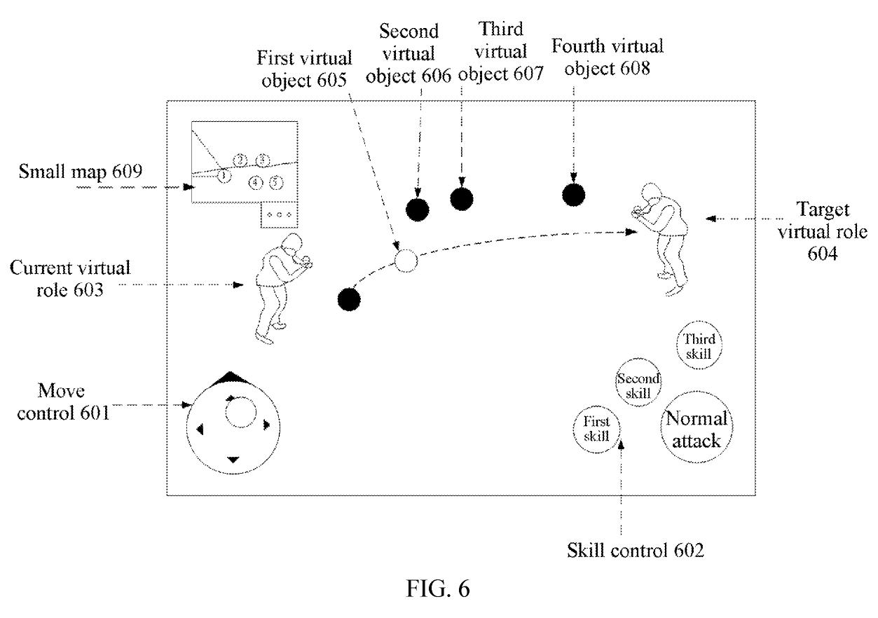

In FIG. 5, after the second skill triggered by the skill control 502 hits the target virtual role for four times, four virtual objects may be displayed in the current virtual scene. Further, a skill effect of the second skill may be upgraded to a target skill effect, that is, four virtual objects may be used as target virtual objects, and the player controls the movement control 501 and the skill control 502 to separately control the first virtual object 505, the second virtual object 506, the third virtual object 507, and the fourth virtual object 508 in sequence. A subsequent control operation on the first virtual object 505 is described below as an example. As shown in FIG. 6, a plurality of virtual objects generated according to a second skill triggered by a skill control 602 are displayed in the virtual scene, including a first virtual object 605, a second virtual object 606, a third virtual object 607, a fourth virtual object 608, and a current virtual role 603. In addition, a small map 609 keeps being displayed in FIG. 6. In this implementation, when four virtual objects generated according to the second skill are displayed in the virtual scene, the second skill triggered by the skill control 602 may be upgraded to a target skill effect. Further, in response to a player further tapping the skill control 602, the first virtual object 605 is determined as the target virtual object, and the first virtual object is adjusted to be in the activated state, and moves along a moving track (shown by a dashed line) indicated in real time by a movement control 601, to attack a target virtual role 604. In FIG. 6, a solid icon object at a start end of the moving track is indicated as a to-be-activated first virtual object, and a hollow icon object in the moving track is in the activated state and is the controlled first virtual object 605. The first virtual object in the to-be-activated state indicated on the moving track is not displayed in a process of controlling the virtual object to move.

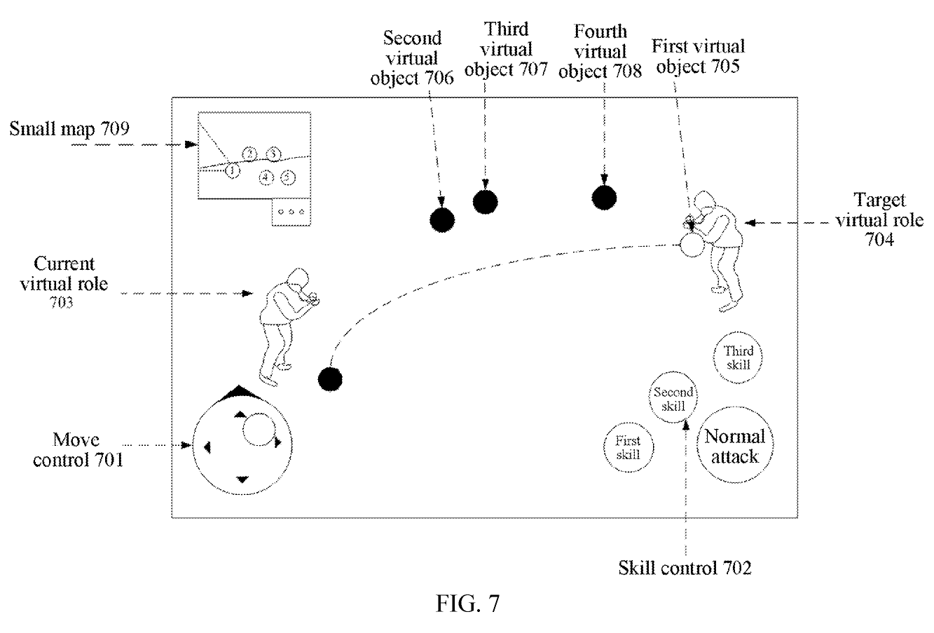

As shown in FIG. 7, a skill control 702, a current virtual role 703 and a target virtual role 704 in an interactive state in a virtual scene, and a first virtual object 705, a second virtual object 706, a third virtual object 707, and a fourth virtual object 708 that are generated according to the second skill continue to be displayed on the interface. In FIG. 7, continuing to respond to real-time slide control on a movement control 701, the first virtual object 705 in the activated state moves and hits the target virtual role 704.

In S208, the role status may be configured for representing a state of the virtual role, and the role status may be, but is not limited to, a life state, a damage state, a defense state, a moving speed state, or the like, which is not specifically limited herein. The target virtual object hitting the target virtual role may affect the role status of the target virtual role, leading to a change of the role status. Therefore, the role status of the target virtual role may be updated in response to the target virtual role hit by the target virtual object. The updating the role status of the target virtual role may be lowering or raising the role status of the target virtual role. For example, the role status, such as the life state, the defense state, or the damage state, of the target virtual role may be lowered when the target virtual role and the current virtual role belong to different camps, or the role status, such as the life state, the defense state, or the damage state, of the target virtual role is enhanced when the target virtual role and the current virtual role belong to the same camps.

In an implementation, when the virtual scene includes a reference virtual role (an enemy hero) located in a different role camp from the current virtual role, and a target virtual role (a friend hero) located in the same role camp as the current virtual role, the interaction condition may be that an attack skill released by the current virtual role hits the reference virtual role for three times. Further, when the attack skill released by the current virtual role hits the reference virtual role for three times, a summoned creature (that is, the foregoing virtual object) is displayed at a location at which the reference virtual role is hit for the last time. In response to a trigger operation on the target skill control, the virtual object may be activated to be called as the target virtual object, and further, in response to a trigger operation on the direction control, the target virtual object may be controlled to treat the target virtual role.

In another implementation, when the virtual scene includes a reference virtual role (a first enemy hero) and a target virtual role (a second enemy hero) that are in different role camps from the current virtual role, the interaction condition may be that an attack skill released by the current virtual role hits the reference virtual role for three times. Further, when the attack skill released by the current virtual role hits the reference virtual role for three times, a summoned creature (that is, the foregoing virtual object) is displayed at a location at which the reference virtual role is hit for the last time. In response to a trigger operation on the target skill control, the virtual object may be activated to be called as the target virtual object, and further, in response to a trigger operation on the direction control, the target virtual object may be controlled to damage the target virtual role.

According to the foregoing implementation, whether the interactive operation of the current virtual role meets the interaction condition is determined, a new controllable virtual object is displayed when the interaction condition is met, and in response to a control operation, an interactive operation between virtual roles is implemented by using the controllable virtual object, so that different control operations are performed on different types of virtual objects to release a skill, virtual object control methods are enriched, game experience of a player is improved, interaction of the game can be improved, and the player participates in the game more immersive, strengthening immersion, engagement, and inventiveness of the game.

In an implementation, the displaying, when an interactive operation triggered by the current virtual role meets an interaction condition, at least one virtual object at an interaction key location associated with the interactive operation in the virtual scene includes at least one of the following:

manner 1: determining, when the interactive operation triggered by the current virtual role hits a first virtual role, that the interactive operation triggered by the current virtual role meets the interaction condition, and displaying the at least one virtual object at a role location of the first virtual role, the interaction key location including the role location of the first virtual role;

manner 2: determining, when the interactive operation triggered by the current virtual role defends against an attack operation triggered by a second virtual role, that the interactive operation triggered by the current virtual role meets the interaction condition, and displaying the at least one virtual object at a role location of the current virtual role, the interaction key location including the role location of the current virtual role; and

manner 3: determining, when a first operation track of the interactive operation triggered by the current virtual role intersects with a second operation track of an interactive operation triggered by a third virtual role, that the interactive operation triggered by the current virtual role meets the interaction condition, and displaying the at least one virtual object at a location corresponding to a track intersection point of the first operation track and the second operation track, the interaction key location including the location corresponding to the track intersection point.

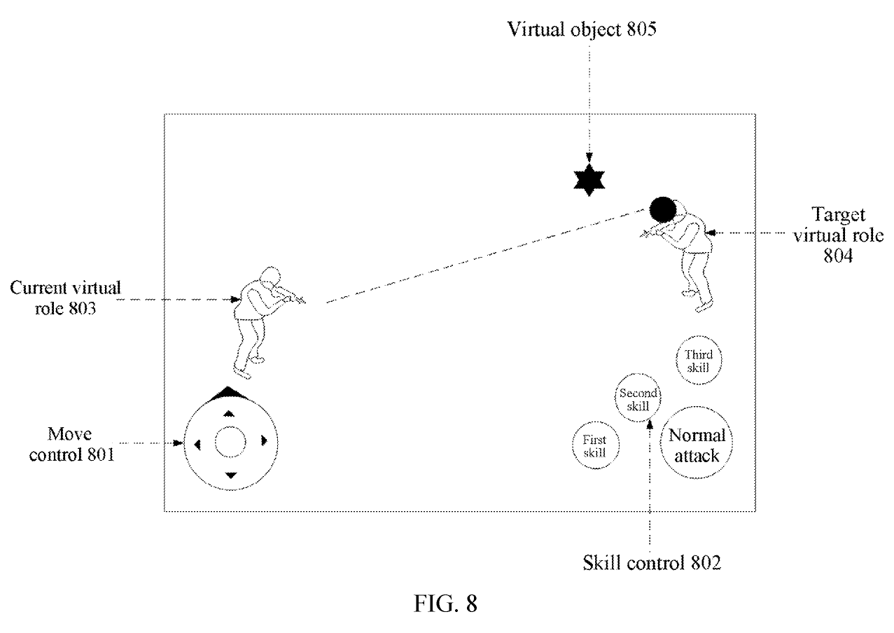

In a manner, triggering the interactive operation by the current virtual role includes, but is not limited to, when an interactive operation such as an attack operation (for example, a virtual bullet, a virtual bomb, a virtual light wave, or virtual boxing gloves), a treatment operation (for example, a virtual medicine or a virtual herb), or a defense operation (for example, a virtual protective suit or a virtual armor) hits the first virtual role, as shown in FIG. 8, a current virtual role 803 controls a movement control 801 and a skill control 802 to hit a target virtual role 804 in response to a control operation of a player, displays a virtual object 805, and determines that the interactive operation triggered by the current virtual role 803 meets an interaction condition. The first virtual role may be the target virtual role. Alternatively, the first virtual role may be another virtual role in a different camp from or the same camp as the target virtual role. That is, the first virtual role may be a teammate or an opponent of the target virtual role. This is merely an example herein and is not specifically limited.

After it is determined that the interactive operation triggered by the current virtual role meets the interaction condition, displaying at least one virtual object at the location of the first virtual role may be but is not limited to: displaying one virtual object or a plurality of virtual objects at the role location of the first virtual role after each interactive operation is performed, or displaying at least one virtual object at the role location of the first virtual role when a quantity of times of hitting the first virtual role reaches a preset threshold or a hitting damage reaches a specific threshold. This is not specifically limited herein. The virtual object includes, but is not limited to, a controllable life entity, a summoned creature, or the like that has a type the same as that of the current virtual role or the target virtual role, an attack, defense, or a treatment prop, or the like. The virtual object may provide a plurality of types of auxiliary skills, which include, but are not limited to, an auxiliary protection skill, an auxiliary attack skill, an auxiliary viewing skill, an auxiliary resource collection skill, or the like. The interaction key location includes the role location of the first virtual role.

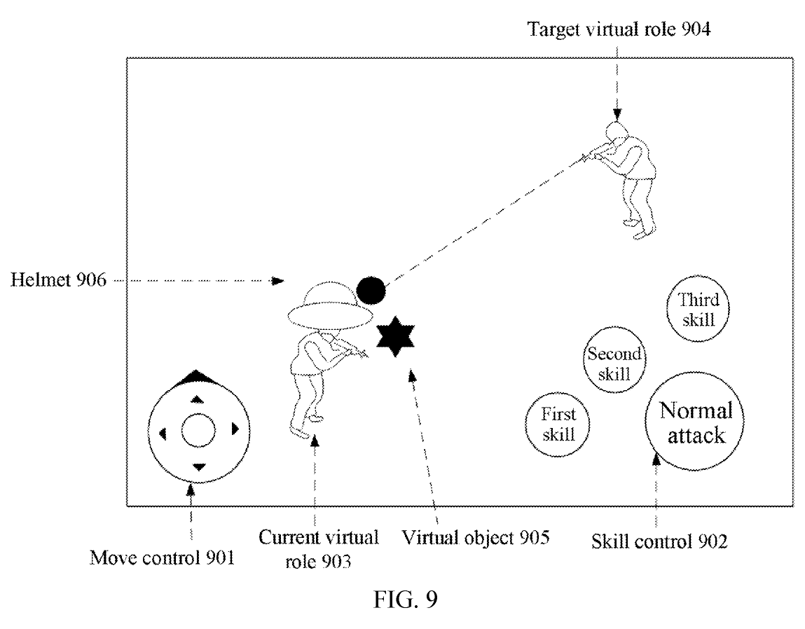

In another manner, when the interactive operation triggered by the current virtual corner defends against the attack operation triggered by the second virtual role, as shown in FIG. 9, a current virtual role 903 controls a movement control 901 and a skill control 902 in response to a control operation of a player, stops an attack operation on a target virtual role 904 in response to a control operation on a helmet 906, and shows a virtual object 905. It is determined that the interactive operation triggered by the current virtual role 903 meets the interaction condition. The second virtual role may be the target virtual role, or may be another virtual role in a different camp from or the same camp as the target virtual role. That is, the second virtual role may be a teammate or an opponent of the target virtual role, which is merely an example herein and is not specifically limited.

After it is determined that the defense operation is performed on the interactive operation triggered by the current virtual role, and the interaction condition is met, displaying at least one virtual object at the role location of the current virtual role may be but is not limited to: displaying one virtual object or a plurality of virtual objects at the role location of the current virtual role after each defense operation, or selecting or automatically displaying, when a quantity of defense operations reaches a specific quantity of times or a defense operation reaches a specific threshold, at least one virtual object at a location at which the current virtual role completes a defense operation last time, which is not specifically limited herein. The virtual object includes, but is not limited to, a controllable life entity, a summoned creature, or the like that has a type the same as that of the current virtual role or the target virtual role, an attack, defense, or a treatment prop, or the like. The virtual object may provide a plurality of types of auxiliary skills, which include, but are not limited to, an auxiliary protection skill, an auxiliary attack skill, an auxiliary viewing skill, an auxiliary resource collection skill, or the like. The interaction key location includes the role location of the current virtual role. In an implementation, when the current virtual role successfully defends against an attack operation triggered by a virtual role of an enemy camp, at least one virtual object may be displayed at the location of the current virtual role.

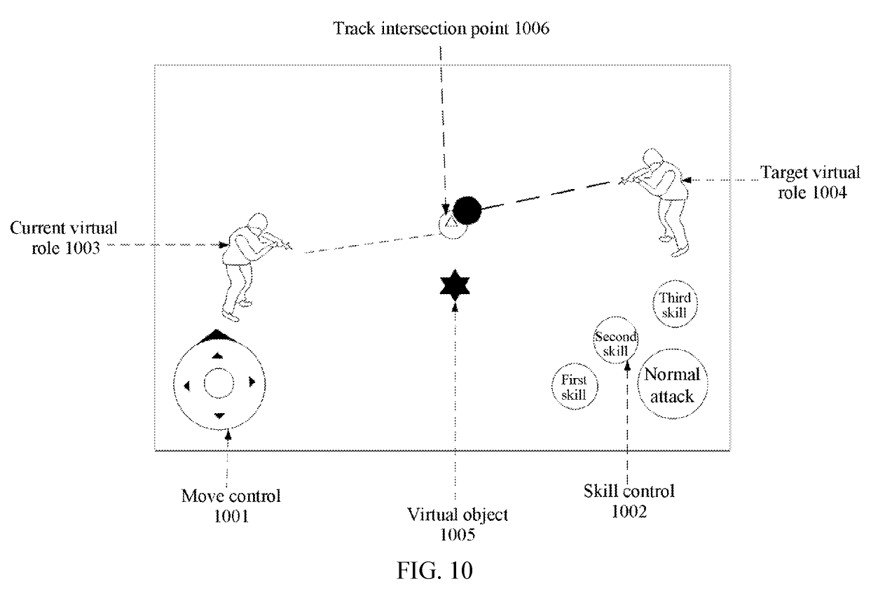

In still another manner, when a first operation track of the interactive operation triggered by the current virtual role intersects with a second operation track of an interactive operation triggered by a third virtual role, as shown in FIG. 10, a current virtual role 1003 controls a movement control 1001 and a skill control 1002 to complete the interactive operation in response to the control operation of the player, a track intersection point 1006 occurs on the first operation track generated by the current virtual role 1003 and the second operation track generated by the target virtual role 1004 by releasing a skill, and a virtual object 1005 appears. A triangle is the track intersection point 1006 at which the first operation track of the interactive operation of the current virtual role intersects with the second operation track of the interactive operation of the third virtual role. It is determined that the interactive operation triggered by the current virtual role 1003 meets the interaction condition. The third virtual role may be the target virtual role, or may be another virtual role in a different camp from or the same camp as the target virtual role. That is, the third virtual role may be a teammate or an opponent of the target virtual role, which is merely an example herein and is not specifically limited.

It is determined that the first operation track triggered by the interactive operation triggered by the current virtual role intersects with the second operation track triggered by the interactive operation of the third virtual role. After the interaction condition is met, at least one virtual object is displayed at the location corresponding to the track intersection point of the first operation track and the second operation track, which may be but is not limited to: displaying one virtual object or a plurality of virtual objects at a location of a track intersection point in a virtual scene each time after the first operation track intersects the second operation track, or when a quantity of times of track intersection reaches a specific quantity of times or a specific track intersection (skill "collision") reaches a specific threshold, selecting or automatically displaying at least one virtual object at the track intersection location, which is not specifically limited herein. The virtual object includes, but is not limited to, a controllable life entity, a summoned creature, or the like that has a type the same as that of the current virtual role or the target virtual role, an attack, defense, or a treatment prop, or the like. The virtual object may provide a plurality of types of auxiliary skills, which include, but are not limited to, an auxiliary protection skill, an auxiliary attack skill, an auxiliary viewing skill, an auxiliary resource collection skill, or the like. The interaction key location includes the location corresponding to the track intersection point.

According to the foregoing implementation of this application, it may be determined that the interactive operation triggered by the current virtual role meets the interaction condition according to a plurality of interactive operations triggered by the current virtual role, and the interaction key location for displaying the virtual object in different situations is determined, thereby enriching methods for determining the location of the virtual object when the trigger operation meets the interaction condition. By using the plurality of methods for determining the interaction key location of the virtual object, the player can properly develop an attack and interaction policy, thereby increasing the strategy of the game, and enriching the player's movement control and attack policy on the virtual object. Further, the foregoing implementation provides a brand new virtual object control method, solving a technical problem that an existing virtual scene control mechanism has a single virtual object control method.

In an implementation, the displaying at least one virtual object at an interaction key location associated with the interactive operation in the virtual scene includes at least one of the following:

manner 1: determining, when the interactive operation is a skill operation, a first object type of the virtual object according to a skill track display style corresponding to the skill operation, and displaying the virtual object of the first object type at the interaction key location; and

manner 2: determining, when the interactive operation is an attack operation, a second object type of the virtual object according to a role display style of the current virtual role, and displaying the virtual object of the second object type at the interaction key location.

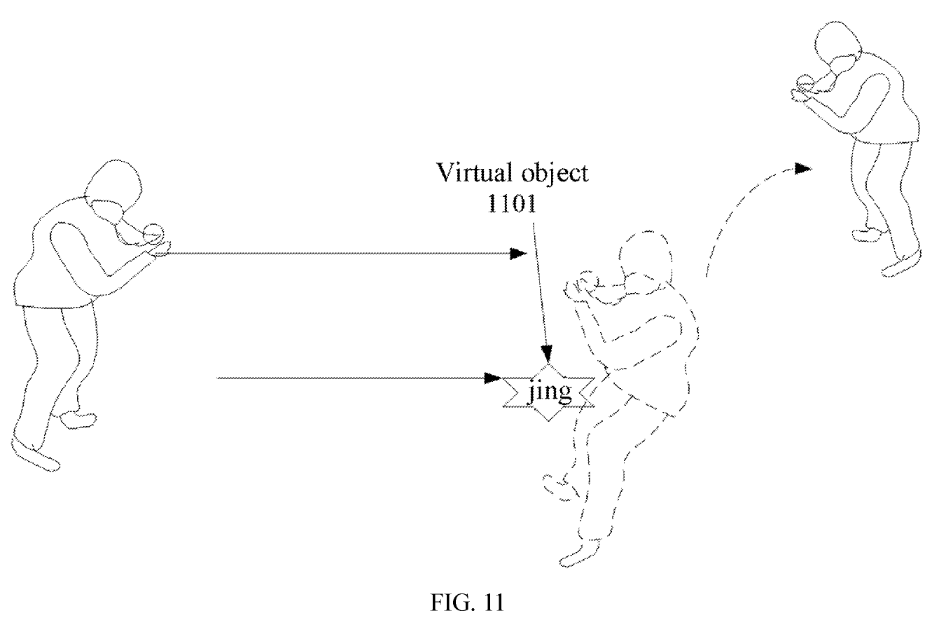

In an implementation, when the interactive operation is a skill operation, the first object type of the virtual object is determined according to a skill track display style corresponding to the skill operation. For example, as shown in FIG. 3, if a skill is displayed as a virtual ink, the first object type of the virtual object is an ink blob. As shown in FIG. 11, if a skill is displayed as virtual calligraphy word, a first object type of a virtual object is virtual calligraphy word, and a virtual object 1101 in the figure is virtual calligraphy word "jing". If a skill is displayed as a flight track of an arrow, the first object type of the virtual object is a to-be-controlled virtual arrow. If the skill is displayed as a piece of virtual flame, the first object type of the virtual object is a fire blob or the like, which is not specifically limited herein. The virtual object of the first object type is displayed at the interaction key location. The interaction key location may be, but is not limited to, an end location of the interactive operation (for example, a target skill release hit location, a target skill release time end location, a location at which the target skill reaches a farthest distance, and a location at which target skill release is interrupted), a location on a moving track of the target virtual role (for example, a location may be actively or randomly selected on the track as the interaction key location), a location at which skills respectively released by the current virtual role and the target virtual role "collide", and the like. This is not specifically limited herein.

In another implementation, when the interactive operation is an attack operation, the second object type of the virtual object is determined according to the role display style of the current virtual role. The attack operation may be a basic attack operation such as throwing a fist, shooting an arrow, and bayonet charge. In addition, the virtual object of the second object type is displayed at the interaction key location. When the current virtual role is a virtual zombie, a role display style of the virtual object may be a virtual zombie. When the current virtual role is a virtual frog, a role display style of the virtual object may be a virtual tadpole or the like. The interaction key location may be, but is not limited to, an attack operation end location (for example, an attack hit location, an attack time end location, or an attack farthest distance location), a location on a moving track of the target virtual role (for example, a location may be actively or randomly selected on the track as the interaction key location), or the like, which is not specifically limited herein.

According to the foregoing implementation of this application, when an interactive operation meets different operations, virtual objects of different object types are correspondingly displayed at an interaction key location according to different situations, thereby enriching object types of the virtual objects. Further, different operation control may be performed on the different types of virtual objects, for example, flight, springing, exploding, and shocking, to implement operations such as attacking, treatment, and defense, thereby enhancing immersion and engagement of a game, and enriching virtual object control methods.

In an implementation, before the determining, when the interactive operation triggered by the current virtual role hits a first virtual role, that the interactive operation triggered by the current virtual role meets the interaction condition, and displaying the at least one virtual object at a role location of the first virtual role, the method further includes:

S1: obtaining, when the interactive operation is a skill operation, a skill track direction of the skill operation in response to a trigger operation on the skill operation;

S2: dynamically displaying a skill track of the skill operation according to the skill track direction by using the role location of the current virtual role as a start location;

S3: determining, when a track length of the displayed skill track is less than or equal to a preset distance and the displayed skill track reaches the role location of the first virtual role, that the interactive operation triggered by the current virtual role hits the first virtual role; and

S4: canceling displaying of the skill track when the track length of the displayed skill track is equal to the preset distance and the displayed skill track does not reach the role location of the first virtual role.

In this implementation, when the interactive operation is a skill operation, the skill track direction of the skill operation is obtained in response to a trigger operation performed on the skill operation. As shown in FIG. 5, the track of the skill operation is dynamically displayed according to the skill track direction by using the role location of the current virtual role (a skill release location is used as the role location of the current virtual role) as a start location. The skill track of the skill operation is dynamically displayed according to the skill track direction if the track length of the displayed skill track is less than or equal to the preset distance, and the displayed skill track reaches the role location of the first virtual role. The role location of the first virtual role may be a location hit by a skill attack, a location at which the first virtual role performs secondary movement (for example, movement such as collision, knockback, and evasion), and then it is determined that the interactive operation triggered by the current virtual role hits the first virtual role.

Displaying of the skill track is canceled when the track length of the displayed skill track is equal to the preset distance and the displayed skill track does not reach the role location of the first virtual role.

A manner of canceling displaying of the skill track is not limited in this embodiment of this application. In an implementation, displaying of the skill track may be directly and instantly canceled. In another implementation, displaying of the skill track may be canceled according to a target dynamic style. The target dynamic style may be that in a process of canceling displaying of the skill track, a related parameter of canceling displaying of the skill track may be dynamically adjusted. For example, a speed, a direction, duration, or a color of canceling displaying of the skill track may be adjusted, or an effect of the dynamic style may be changed according to a screen size. Specifically, the target dynamic style may be an effect such as gradually becoming hidden in ink, dimming in fire, or receding in water waves.

In an implementation, the skill track is displayed after a skill operation is triggered. If the skill hits a role within a preset time and distance, the skill track is displayed from a role location at which the current virtual role is located to a role location at which the first virtual role is located. If the skill is released for more than a particular time and a movement distance, the skill track is displayed in a gradually hidden display style. As shown in FIG. 3, when the virtual object reaches a farthest distance and does not hit the role, and ink gradually becomes hidden.

According to the foregoing implementation of this application, in response to a trigger operation of a skill operation, a skill track of the skill operation is displayed according to a skill track direction by using the role location of the current virtual role as the start location, the first virtual role is hit when a track length is less than or equal to a preset distance, and displaying of the skill track is canceled when the track length is equal to the preset distance and the role location of the first virtual role is not reached, thereby enriching skill track display methods and track styles, and enabling a player to trigger displaying of the skill track style and effect by trying different prop and skill combinations, so that the game is more interesting and diversified.

In an implementation, during the determining, when the interactive operation triggered by the current virtual role hits a first virtual role, that the interactive operation triggered by the current virtual role meets the interaction condition, and displaying the at least one virtual object at a role location of the first virtual role, the method further includes:

S1: determining, when the first virtual role and the current virtual role are in the same role camp, that gain effect impact is caused to the first virtual role; and

S2: determining, when the first virtual role and the current virtual role are in different role camps, that negative effect impact is caused to the first virtual role.

In this implementation, when the first virtual role and the current virtual role are in the same role camp, for example, the first virtual role and the current virtual role are in the same battle team or the allied battle team, which is not specifically limited herein. The determining to cause gain effect impact on the first virtual role may be specifically: increasing a role attribute such as strength, intelligence, agility, treatment, recovery, or evasion, increasing a role health point, a mana value, increasing a role damage value, a defense value, increasing a role moving speed, a critical strike rate, or a hit rate, or shortening a skill cooling time, which is not specifically limited herein.

In an implementation, when the first virtual role and the current virtual role are in different role camps, for example, the first virtual role and the current virtual role are in different battle teams or enemy battle teams, which is not specifically limited herein. The determining to cause negative effect impact on the first virtual role may be specifically reducing a role attribute such as strength, intelligence, agility, treatment, recovery, or evasion, reducing a role health point, a mana value, reducing a role damage value, a defense value, reducing a role moving speed, a critical strike rate, or a hit rate, or prolonging a skill cooling time, which is not specifically limited herein.

Specifically, the target virtual role may be hit by a skill released by the current virtual role for three times. The interactive operation of the current virtual role meets the interaction condition. A summoned creature (a virtual role) is displayed at a location at which the target virtual role is hit for the last time, and the summoned creature is activated at once, for example, a virtual object 805 in FIG. 8. When the target virtual role is a teammate, the summoned creature heals or defends against the target virtual role. For example, a health point of the target virtual role may be increased, or a damage value of the target virtual role may be reduced when the target virtual role is an enemy. This is only an example, and is not specifically limited.

According to the foregoing implementation of this application, when the first virtual role and the current virtual role are in the same or different camps, the first virtual role is affected differently, and a player may substitute into an identity of a game role more deeply and experience a more real and rich game world, which can enrich control operations of the player on the virtual role, control the virtual role to hurt an enemy and heal a friend, and increase immersion and engagement of a game, thereby solving a technical problem that a virtual object control method in a related method is single.

In an implementation, the determining, when the first virtual role and the current virtual role are in different role camps, that negative effect impact is caused to the first virtual role includes at least one of the following:

manner 1: adjusting an active state parameter of the first virtual role from a first value to a second value, where it is determined that the first virtual role is in an active state in the virtual scene when the active state parameter of the first virtual role is greater than or equal to 0, the second value being less than the first value;

manner 2: adjusting a moving state parameter of the first virtual role from a third value to a fourth value, the moving state parameter being configured for indicating a moving speed of the first virtual role in the virtual scene, and the fourth value being less than the third value; and

manner 3: updating a knockback parameter for the first virtual role according to the interactive operation, and when the knockback parameter of the first virtual role meets a value condition, displaying that the first virtual role is flying in the virtual scene according to a preset flight track.

In one case, an active state parameter of the first virtual role may be adjusted from a first value to a second value. The active state parameter may be but is not limited to an attribute of the role, and is not specifically limited herein. When the active state parameter of the first virtual role is greater than or equal to 0, it is determined that the first virtual role is in the active state in the virtual scene, and the second value is less than the first value. For example, a health point of 60 drops of blood of the first virtual role is reduced to 40 drops of blood.

In another case, a moving state parameter of the first virtual role may be adjusted from a third value to a fourth value. The moving state parameter is configured for indicating a moving speed of the first virtual role in the virtual scene. The moving state parameter may be, but is not limited to, a moving speed during attack or evasion. This is not limited herein. The fourth value is less than the third value. For example, the moving speed of the first virtual role is reduced from 5 m/s to 4 m/s.

In still another case, a knockback parameter may be updated for the first virtual role according to the interactive operation. The knockback parameter may be, but is not limited to, indicating that the first virtual role is knocked back to move to a place at a distance of a particular unit to an original location after the first virtual role is hit. When the knockback parameter of the first virtual role meets a value condition, the first virtual role is displayed to fly in the virtual scene according to a preset flight track (as shown in FIG. 11, the right-side virtual role is knocked back). The value condition may be but is not limited to reaching a preset threshold, fighting for particular duration, an attribute value of the first virtual role, the target virtual role, or the current virtual role reaches a preset threshold, or the like. This is not limited herein. When a particular knockback parameter reaches a preset threshold, the first virtual role may be knocked back, so that the first virtual role flies, or a knockback parameter is accumulated each time, and after the accumulated knockback parameter reaches the preset threshold, the first virtual role is knocked back, so that the first virtual role flies, or each updated knockback parameter may be combined with different weights, to obtain a final knockback parameter through calculation, and the final knockback parameter is compared with the preset threshold, so that the first virtual role is knocked back when the preset threshold is reached or the like, so that the first virtual role flies. This is not specifically limited herein.

According to the foregoing implementation of this application, negative impact on the first virtual role may be determined by selecting a manner of adjusting at least one of an active state parameter, a moving state parameter, and a knockback state parameter. On one hand, the game may be more challenging, so that the player continuously adjusts a game policy. On the other hand, the interactive operation causes different impact results for the virtual role, thereby enriching manners in which the player controls the virtual object to operate the virtual role.

In an implementation, before the controlling, when a target virtual object of the at least one virtual object is in an activated state, the target virtual object in response to a control operation on the target virtual object to move according to a moving track indicated by the control operation, the method further includes at least one of the following:

manner 1: configuring, when an object quantity of the at least one virtual object is greater than or equal to a first quantity, the target virtual object determined from the at least one virtual object to be in the activated state in response to a trigger operation on a target skill control, the target skill control being configured for triggering the interactive operation of the current virtual role and configuring the activated state of the target virtual object; and

manner 2: determining, when the object quantity of the at least one virtual object is greater than or equal to the first quantity, to configure the target virtual object to be in the activated state in response to a selection operation on the target virtual object.

In a manner, the first quantity may be that a preset value is determined as the first quantity, or different first quantities may be set according to different fighting phases, or the first quantity may be determined according to an attribute value of the current virtual role or the target virtual role. For example, when the health point of the current virtual role is less than 50%, the first quantity is set to 3 units, or when the health point of the current virtual role is greater than 50%, the first quantity is set to 2 units. This is not specifically limited herein. When an object quantity of virtual objects is greater than or equal to the first quantity, the target virtual object determined from the at least one virtual object is configured to be in the activated state in response to a trigger operation on a target skill control, the target skill control being configured for triggering the interactive operation of the current virtual role and configuring the activated state of the target virtual object. There may be one or more target virtual objects. The target virtual objects may be immediately configured to be in the activated state after a quantity of virtual objects meets a condition, or the target virtual objects may be automatically or randomly configured to be in the activated state according to a combat situation. This is not specifically limited herein.

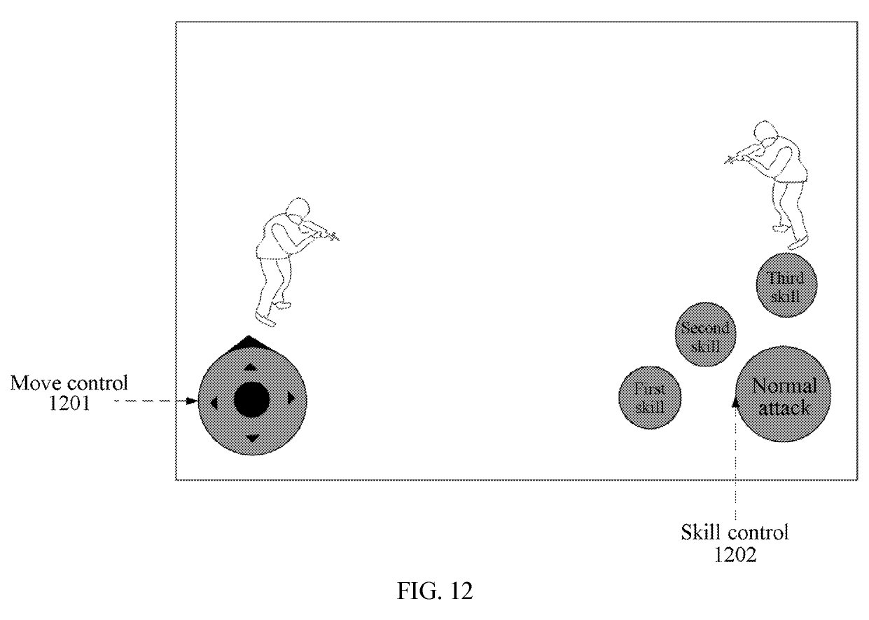

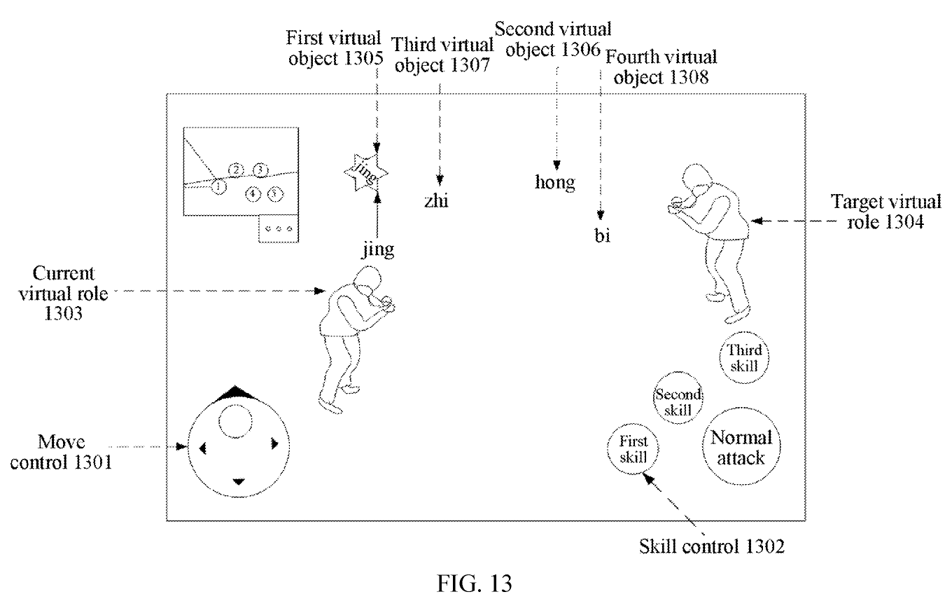

In an implementation, for example, the first quantity is 3, the object quantity of the at least one virtual object is 4, and after the target skill control is triggered, a virtual object closest to an enemy having the lowest health point on the current site is determined as the target virtual object. A skill control 802 shown in FIG. 8 is triggered to configure the target virtual object to be in the activated state. The target virtual object in FIG. 8 is a virtual object 805, and the target virtual object starts to attack the enemy having the lowest health point on the current site. Alternatively, as shown in FIG. 12, a movement control 1201 and a skill control 1202 that control the target virtual object are in a gray state that cannot be operated, and the target virtual object cannot be selected from the current virtual scene. The target virtual object cannot be configured to be in the activated state. An operation on the target virtual object may be an interactive operation associated with the current virtual role (for example, the same operation), or may be unrelated to the current virtual role. For example, the current virtual role performs a bayonet charge operation, and the target virtual object also performs a bayonet charge operation, or the target virtual object automatically performs an evasion and defense attack. This is not specifically limited herein.

In another manner, when the quantity of objects of the at least one virtual object is greater than or equal to the first quantity, in response to a selection operation on the target virtual object, it is determined that the target virtual object is configured to be in the activated state. That is, in this implementation, the virtual object may be manually selected according to a fighting situation and a fighting policy, to determine the target virtual object, and then the target virtual object is configured to be in the activated state.

In this implementation, the target virtual object is configured to be in the activated state in a plurality of manners, thereby enriching virtual object control methods, and further solving a technical problem that an existing virtual scene control mechanism has a single virtual object control method.

In an implementation, before the configuring the target virtual object determined from the at least one virtual object to be in the activated state in response to a trigger operation on a target skill control, the method includes:

S1: Determine, in response to a control operation on the target skill control in a first control state, that the current virtual role triggers the interactive operation, the target skill control in the first control state being configured for triggering the interactive operation of the current virtual role; and

S2: Switch the target skill control from the first control state to a second control state when the object quantity of the virtual object is greater than or equal to the first quantity, the target skill control in the second control state being configured for configuring the activated state of the target virtual object.

In this implementation, in response to a control operation on the target skill control in the first control state, for example, a control operation such as tapping, holding, or sliding, where the control state may be a to-be-enabled state, a disabled state, or an enabled state, it is determined that the current virtual role triggers the interactive operation, and the target skill control in the first control state is configured for triggering the interactive operation on the current virtual role.

When the object quantity of the virtual object is greater than or equal to the first quantity, the target skill control is switched from the first control state to the second control state. The target skill control in the second control state is configured for configuring the activated state of the target virtual object, for example, turning an attack of the target virtual object to defense, or switching a skill enabled state of the target virtual object to a pause state. The control may further be highlighted, grayed out, emphasized, or the like.

Specifically, in response to operations of a player on a movement control 601 and a skill control 602 in FIG. 6, a current virtual role 603 is controlled to release a first virtual object 605 (a virtual ink blob) to attack a target virtual role 604, and when a quantity of virtual ink blobs hitting enemies accumulates to 4 (assuming that the first quantity is 4), the target skill control is switched from the virtual ink blob released in the first control state to a virtual calligraphy word released in the second control state, such as a first virtual object 1305, a second virtual object 1306, a third virtual object 1307, and a fourth virtual object 1308 in FIG. 13 (assuming that the four virtual ink blobs are respectively upgraded to four virtual calligraphy words in this case). In this way, the current virtual role may control the target skill control in the second control state to perform the interactive operation, and a current virtual role 1303 operates the first virtual object 1305 with the word "jing" to attack a target virtual role 1304. In the figure, a moving track of the virtual calligraphy word is upward from a location at which the small-font virtual calligraphy word "jing" is located to a location at which the bold and larger virtual calligraphy word "jing" is located.

According to the foregoing implementation of this application, different control states are set for the same skill control, so that a player can select different skill using manners according to a current situation, thereby increasing depth and strategy of a game, and increasing difficulty of the game, so that the player needs more skills and strategies to deal with different situations, thereby improving challenge and fun of the game, and further solving a technical problem that an existing virtual scene control mechanism has a single virtual object control method.

In an implementation, after the updating a role status of the target virtual role in response to hitting the target virtual role by the target virtual object, the method further includes:

switching the target skill control from the second control state to the first control state when the object quantity of the at least one virtual object displayed in the virtual scene is less than or equal to a second quantity.

In this implementation, when the target skill control is in the first control state, the first skill effect (that is, the foregoing interactive operation) is released to the target virtual role in response to a trigger operation on the target skill control. For example, in FIG. 5, a current virtual role 503 releases a virtual ink blob (a first skill in the first control state) to attack a target virtual role 504. In addition, when the first skill effect hits the target virtual role 504 (in FIG. 5, a fourth virtual object 508 hits the target virtual role 504), it is determined that the interactive operation meets the interaction condition (for example, the interaction condition needs to be met by hitting four times). In addition, in the virtual scene, a virtual prop (that is, the foregoing virtual object) is displayed at a location at which the target virtual role is hit, and a target skill control is adjusted to be displayed in the second control state. As shown in FIG. 13, four virtual ink blobs are respectively upgraded to four virtual calligraphy words (the first skill in the second control state).

In response to a trigger operation on the target skill control in the second control state, the target virtual object, for example, the virtual object 1305 in FIG. 13, is determined. Further, in response to a control operation on the target virtual object, the target virtual object is controlled to attack the target virtual role 1304. That is, in FIG. 13, a word "jing" (used as the target virtual object) on the first virtual object 1305 hits the target virtual role 1304.

When the target virtual role is hit, the target skill control is restored to the first control state, indicating that the current target skill control can only be configured for releasing the first skill effect to attack the target virtual role, that is, the attack state of the virtual calligraphy word is adjusted to the attack state of the virtual ink blob.

In addition, when the first skill effect does not hit the target virtual role, the target skill control may be kept in the first control state (the attack state of the virtual ink blob). This is merely an example and is not specifically limited herein.

According to the foregoing implementation of this application, by switching a control state, a player is enabled to operate a skill more flexibly, to adapt to different game situations, thereby improving operability and smoothness of a game, and further solving a technical problem that an existing virtual scene control mechanism has a single virtual object control method.

In an implementation, the controlling the target virtual object in response to a control operation on the target virtual object to move according to a moving track indicated by the control operation includes:

S1: Determine, in response to a trigger operation on a direction control, that the control operation on the target virtual object is received;

S2: Obtain a control direction determined according to the direction control, and control the target virtual object to move according to the control direction; and

S3: Control the target virtual object to move according to the updated control direction when the control direction determined by the direction control is updated.

In this implementation, the target virtual object is controlled according to the received control operation in response to the trigger operation performed by the direction control, the control direction determined according to the direction control is obtained, and the target virtual object is controlled to move according to the control direction. Alternatively, when the control direction determined by the direction control is updated, the target virtual object may be controlled to move according to the updated control direction.

In an implementation, the controlling the target virtual object in response to a control operation on the target virtual object to move according to a moving track indicated by the control operation includes:

S1: Display the target virtual object on a virtual ground in the virtual scene according to a first display style;

S2: Display the target virtual object according to a second display style in response to a trigger operation on a direction control, the second display style being configured for indicating that the target virtual object is in the activated state; and

S3: Obtain a control direction determined according to the direction control, and control, according to the control direction, the target virtual object displayed in the second display style to fly.

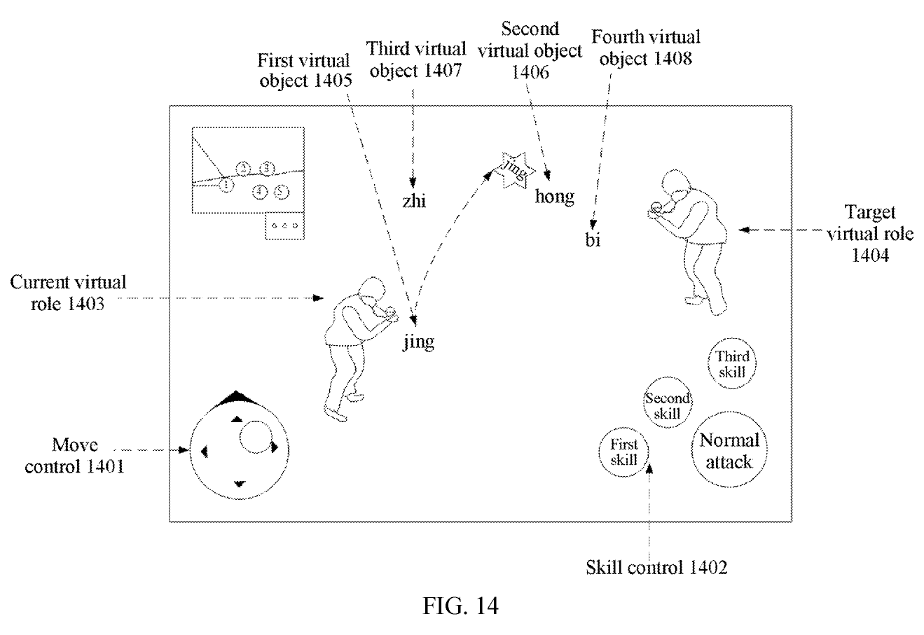

In this implementation, the target virtual object may be displayed in a first display style on a virtual ground in a virtual scene, then the target virtual object is displayed in a second display style in response to a trigger operation on a direction control, the second display style is configured for indicating that the target virtual object is in an activated state, a control direction determined according to the direction control is obtained, and the target virtual object displayed in the second display style is controlled, according to the control direction, to fly. Specifically, the target virtual object may be displayed by using a small water drop on the virtual ground in the virtual scene, and after being changed to a snowflake to float (fly) in response to a trigger operation of the direction control. Alternatively, the target virtual object is displayed on the virtual ground in the virtual scene by using an ink pattern, and after responding to a trigger operation of the direction control, the target virtual object becomes a character to fly. As shown in FIG. 14, a first virtual object 1405 flies in a virtual role style. This is not specifically limited herein.

According to the foregoing implementation of this application, the virtual object displays different display styles in different states and scenarios, thereby enriching entertainment and diversity of a game, and further improving a player's investment and participation.

In an implementation, the configuring the target virtual object determined from the at least one virtual object to be in the activated state includes:

S1: Obtain a display order of the at least one virtual object;

S2: Determine, according to the display order, the first displayed virtual object in the at least one virtual object as the target virtual object; and

S3: Configure the target virtual object to be in the activated state.

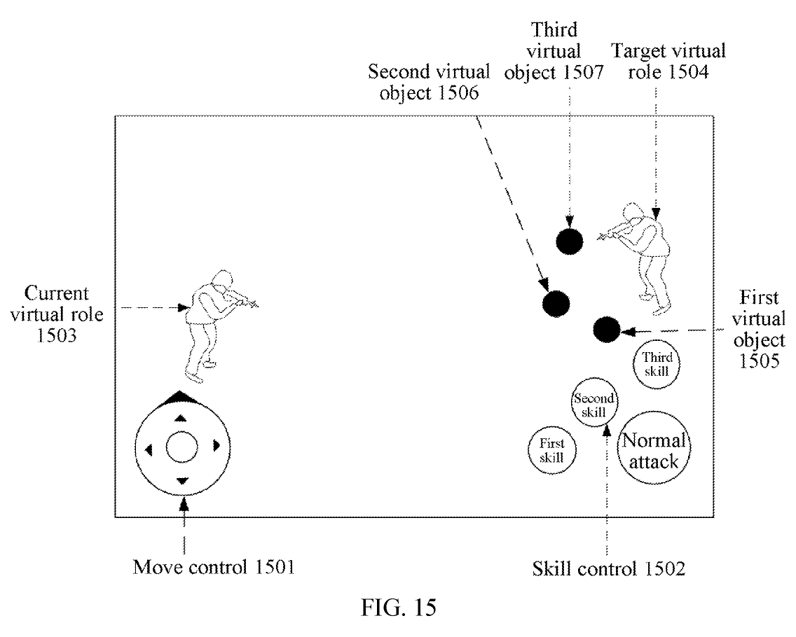

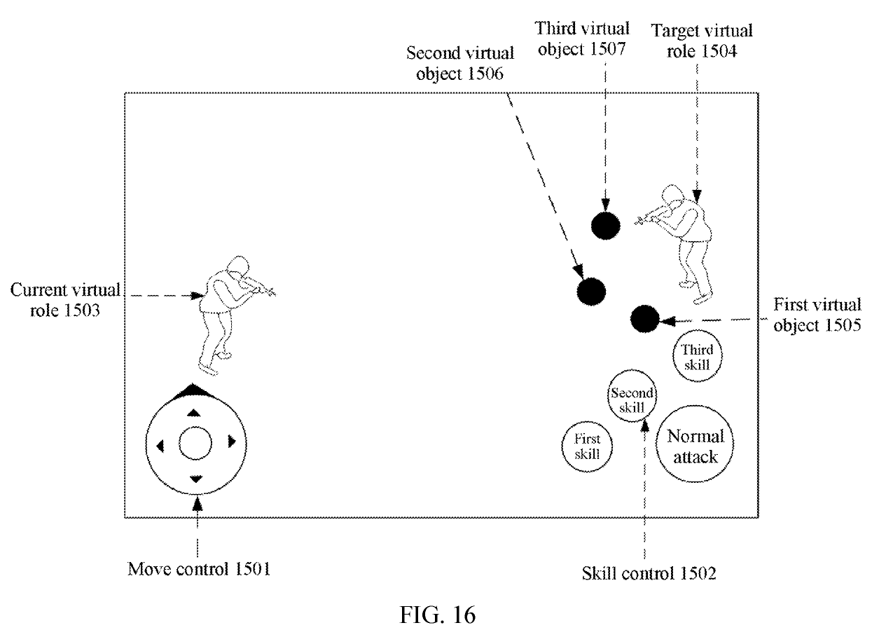

In this implementation, a display order of the at least one virtual object is first obtained. The display order may be a display time order, a display location order, or the like. Then, the first displayed virtual object in the at least one virtual object is determined as the target virtual object according to the display order, and the target virtual object is configured to be in the activated state. In an implementation, when the display order is chronological order for display, the first displayed virtual object is used as the target virtual object, and the first virtual object is set to be in an attack state. As shown in FIG. 15, a current virtual role 1503 controls a movement control 1501 and a skill control 1502 to complete an interactive operation in response to a control operation of a player, for example, hits a target virtual role 1504, one virtual object (a first virtual object 1505, a second virtual object 1506, or a third virtual object 1507) is displayed each time of hit, and a left person is the current virtual role 1503. In the figure, the first virtual object 1505 is transmitted by the current virtual role at a first moment, the second virtual object 1506 is transmitted by the current virtual role at a second moment, and the third virtual object 1507 is transmitted by the current virtual role at a third moment. The first moment is the earliest time. Therefore, the target virtual object is the first virtual object 1505. Alternatively, when the display order is a location order for display, a virtual object whose location is closest to a location of the current virtual role or the target virtual role is used as the target virtual object. As shown in FIG. 16, a current virtual role 1603 controls a movement control 1601 and a skill control 1602 to complete an interactive operation in response to a control operation of a player, for example, hits a target virtual role 1604. One virtual object (a first virtual object 1605, a second virtual object 1606, or a third virtual object 1607) is displayed each time of hit. A left person is the current virtual role 1603. The first virtual object 1605, the third virtual object 1607, and the second virtual object 1606 are successively away from the current virtual role (L1 > L3 > L2). Therefore, the target virtual object is the second virtual object 1605, and the virtual object is set to be in an attack state. This is not specifically limited herein.

According to the foregoing implementation of this application, the target virtual object is further determined according to different methods for determining a display order of the virtual object, thereby providing more choices and policies for a player, and increasing interest and challenge of a game. Different props and skills may be selected according to different situations to deal with enemies or complete tasks, and further solving a technical problem that an existing virtual scene control mechanism has a single virtual object control method.

In an implementation, after the updating a role status of the target virtual role in response to hitting the target virtual role by the target virtual object, the method further includes:

S1: Sequentially determine, when an object quantity of remaining virtual objects in the virtual scene is greater than or equal to 1, the remaining virtual objects as the target virtual object according to the display order;

S2: Display, in response to a control operation on the target virtual object, that the target virtual object is moving according to a moving track indicated by the control operation; and

S3: Update a role status of the target virtual role in response to hitting the target virtual role by the target virtual object.

In this implementation, when a quantity of remaining virtual objects in the virtual scene is greater than or equal to 1, the remaining virtual objects may be sequentially determined as the target virtual object according to a display order. The display order may be a display time order, a display location order, or the like. Further, in response to a control operation on the target virtual object, the target virtual object is displayed to move according to a moving track indicated by the control operation, and the role status of the target virtual role is updated in response to hitting the target virtual role by the target virtual object. In an implementation, if the quantity of remaining virtual objects is 3, virtual objects whose display time in the virtual scene is in ascending order may be sequentially determined as the target virtual objects, and the target virtual objects move according to the control operation. For example, in FIG. 15, a first virtual object 1505, a second virtual object 1506, and a third virtual object 1507 remain. The first virtual object 1505 is transmitted by a current virtual role 1503 at a first moment, the second virtual object 1506 is transmitted by the current virtual role 1503 at a second moment, and the third virtual object 1507 is transmitted by the current virtual role 1503 at a third moment. The first moment is the earliest time, and display time of the first virtual object 1505 in the virtual scene is the longest. Display time of the second virtual object 1506 and the third virtual object 1507 sequentially decreases. Therefore, in this case, the first virtual object 1505 is the target virtual role, and a role status, such as dizziness or losing health, of the target virtual role is updated in response to hitting the target virtual role by the target virtual object. Virtual roles whose locations are closest to the current virtual role or the target virtual role in the virtual scene may be sequentially determined as the target virtual roles, the target virtual roles move according to the control operation, and the role status, such as dizziness or losing health, of the target virtual role is updated in response to hitting the target virtual role by the target virtual object.

In an implementation, after the configuring the target virtual object determined from the at least one virtual object to be in the activated state, the method further includes:

S1: Display status change information when control duration of the control operation on the target virtual object is less than preset duration and the target virtual object hits the target virtual role, the status change information being configured for indicating that the role status of the virtual role is updated; and

S2: Cancel displaying of the target virtual object when the control duration of the control operation on the target virtual object is greater than or equal to the preset duration and the target virtual object has not hit the target virtual role.

The status change information may be, but is not limited to, increase or decrease of a role health point, an energy value, an armor value, a skill cooling state change, a moving speed change, a control state change such as stunned, rooted, silenced, a role form change such as standing and running, and the like. This is not specifically limited herein.

When the control duration of the control operation on the target virtual object is greater than or equal to the preset duration, and the target virtual object does not hit the target virtual role, displaying of the target virtual object is canceled. Specifically, after the control duration in which the current virtual role releases a virtual ink blob exceeds 10s, and the virtual ink blob does not hit the virtual role, the virtual ink blob disappears. For example, the virtual object gradually changes from black to transparent in FIG. 3. This is merely an example and is not specifically limited herein.

In an implementation, the updating a role status of the target virtual role in response to hitting the target virtual role by the target virtual object includes:

S1: Obtain a damage value corresponding to the target virtual object when the role status includes a role active state indicated according to an active state parameter; and

S2: Adjust an active state parameter of the target virtual role from a fifth value to a sixth value according to the damage value, the sixth value being less than the fifth value.

In this implementation, when the role status includes a role active state indicated according to the active state parameter, a damage value corresponding to the target virtual object is obtained, and then the active state parameter of the target virtual role is adjusted from the fifth value to the sixth value according to the damage value. The sixth value is less than the fifth value. For example, an initial blood volume of the target virtual role is 50, a damage value of the target virtual object is 10%, and a blood volume of the target virtual role after damage is 45. This is not specifically limited herein.

According to the foregoing implementation of this application, the active state parameter of the target virtual role is adjusted according to the damage value, to enrich a battle system of a game, make a player expand more diversified battle strategies, increase depth of controlling the virtual role and the battle fun, make the control operation more strategic and interesting, and further solve a technical problem that an existing virtual scene control mechanism has a single virtual object control method.

In an implementation, the obtaining a damage value corresponding to the target virtual object when the role status includes a role active state indicated according to an active state parameter includes:

S1: Separately determine, when the at least one virtual object is sequentially determined as the target virtual object, a damage value corresponding to the target virtual object according to an object order respectively matching the target virtual object, a first damage value corresponding to a target virtual object having an earlier object order being less than or equal to a second damage value corresponding to a target virtual object having a later object order.

In this implementation, when at least one virtual object is sequentially determined as the target virtual object, the damage value corresponding to the target virtual object is determined according to an object order matching the target virtual object. A first damage value corresponding to a target virtual object with a preceding object order is less than or equal to a second damage value corresponding to a target virtual object with a following object order. The object order may be obtained by performing matching according to a time order, a location order, or the like, that is, the object order of the target virtual object may be sequentially determined according to an appearance time order. Alternatively, the object order of the target virtual object is determined sequentially according to a distance between the target virtual object and the current virtual role or the target virtual role. This is not specifically limited herein. The first determined damage value of the target virtual object is less than the second determined damage value of the target virtual object. For example, the initial blood volume of the target virtual role is 50, a damage value of the first projectile is 10, the blood volume after the first projectile implements hitting is 40, a damage value of the second projectile is 5, the blood volume after the second projectile implements hitting is 35, and the blood volume after the damage is 30. The rest can be deduced by analogy.

According to the foregoing implementation of this application, a target object matching order may be set in a plurality of manners, and further a damage value corresponding to the target virtual object is determined according to the object order matched by the target virtual object. Props and skills having different damage values are set to increase difficulty of a game, thereby bringing more challenge and stimulation to a player, and further solving a technical problem that an existing virtual scene control mechanism has a single virtual object control method.

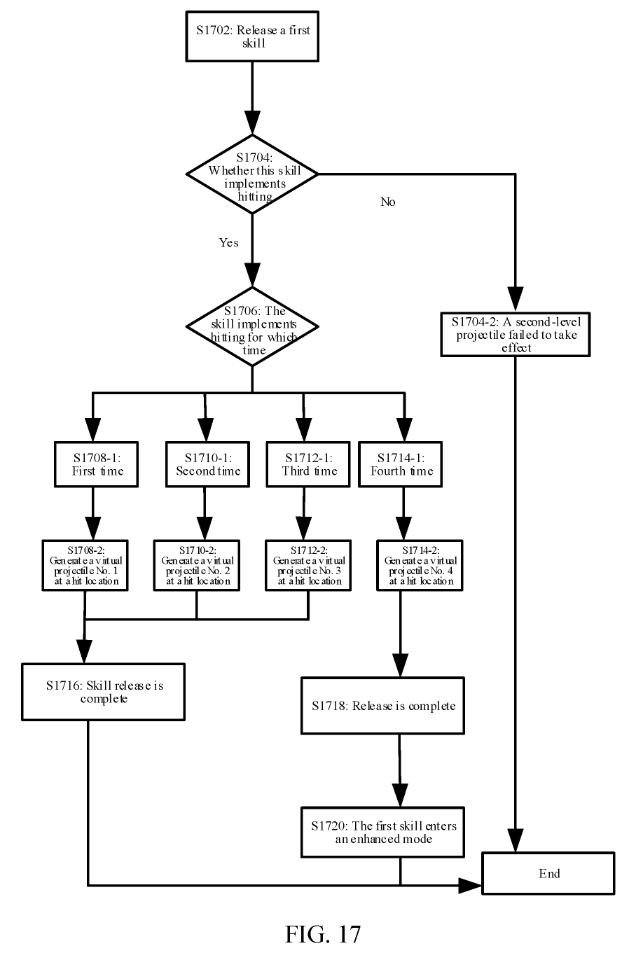

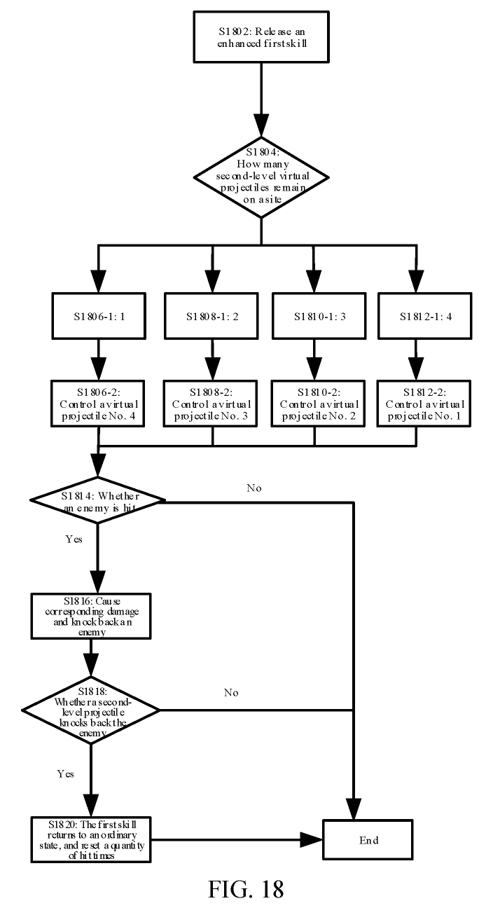

A complete implementation process of this application is described below with reference to FIG. 17 and FIG. 18.

A control process of an ordinary virtual projectile of a virtual object according to this application is described below with reference to FIG. 17.

S1702: Release a first skill (a current virtual role triggers an interactive operation), where a player taps a first skill button, and controls the current virtual role to release a first skill, and determining of an A box (an attack hit box) of a flight prop ink blob occurs in front of the current virtual role.

S1704: Determine whether the skill implements hitting. If not hit, S1704-2 is performed. A second-level virtual projectile fails to take effect, that is, it is determined that the A box of the flight prop ink blob does not cross the box hit by an enemy (a target virtual role), and it is determined that the enemy is not hit. Generation of this second-level virtual projectile fails, and the current round is ended.

If hit, S1706 is performed to determine that the skill implements hitting for which time.

If the skill implements hitting for the first time, S1708-1 is performed, and then S1708-2 is performed, that is, a virtual projectile No. 1 is generated at a hit location. If the skill implements hitting for the second time, S1710-1 is performed, and then S1710-2 is performed, that is, a virtual projectile No. 2 is generated at the hit location. If the skill implements hitting for the third time, S1712-1 is performed, and then S1710-2 is performed, that is, a virtual projectile No. 3 is generated at the hit location. S1716 continues to be performed, and skill release is completed.

Specifically, if it is determined that the A box of the flight prop ink blob intersects the box hit by the enemy, it is determined that the enemy is hit. In this case, a quantity of hit times is determined. If there is no second-level virtual projectile on the site, this is the first-time hit. In this case, a second-level virtual projectile "virtual projectile No. 1" is generated at the hit location. If there is one second-level virtual projectile on the site, this time is the second-time hit, and at this time, a second-level virtual projectile "virtual projectile No. 2" is generated at the hit location. If there are two second-level virtual projectiles already on the site, this time is the third-time hit, and at this time, a second-level virtual projectile "virtual projectile No. 3" is generated at the hit location. If there are three second-level virtual projectiles already on the site, this time is the fourth-time hit, and at this time, a second-level virtual projectile "virtual projectile No. 4" is generated at the hit location. After the previous three second-level virtual projectiles "virtual projectile No. 1", "virtual projectile No. 2", and "virtual projectile No. 3" hit the enemy, this is settled as skill release completion, and current skill settlement is ended.

If the skill implements hitting for the fourth time, S1714-1 is performed, then S1714-2 is performed, and a virtual projectile No. 4 is generated at the hit location. S1718 continues to be performed. Release is completed, and the interactive operation triggered by the current virtual role meets the interaction condition.

S1720 continues to be performed, that is, the first skill enters an enhanced mode.

Finally, the operation is ended. Specifically, if the fourth second-level virtual projectile "virtual projectile No. 4" hits the enemy, the first skill enters the enhanced mode, and then the skill settlement is ended.

The following describes, with reference to FIG. 18, a process of releasing an enhanced skill after the enhanced mode is entered.

S1802: Release an enhanced first skill, where a player taps a first skill button to control a current virtual role to release an enhanced first skill, that is, responding to a control operation on a target virtual object (a projectile) when a virtual projectile is in an activated state.

S1804: Determine how many second-level virtual projectiles remain on a site.

S1806-1 is performed if one second-level virtual projectile remains this time, and then S1806-2 is performed, to control the virtual projectile No. 4. S1808-1 is performed if two second-level virtual projectiles remain, and then S1808-2 is performed, to control the virtual projectile No. 3. S1810-1 is performed if three second-level virtual projectiles remain, and then S1810-2 is performed, to control the virtual projectile No. 2. S1812-1 is performed if four second-level virtual projectiles remain at this time, and then S1812-2 is performed, to control the virtual projectile No. 1.

Specifically, if four virtual projectiles "the virtual projectile No. 1", "the virtual projectile No. 2", "the virtual projectile No. 3", and "the virtual projectile No. 4" remain on the site, the second-level virtual projectile "the virtual projectile No. 1" is controlled to attack the enemy. If three virtual projectiles "the virtual projectile No. 2", "the virtual projectile No. 3", and "the virtual projectile No. 4" remain on the site, the second-level virtual projectile "the virtual projectile No. 2" is controlled to attack the enemy. If two virtual projectiles "the virtual projectile No. 3" and "the virtual projectile No. 4" remain on the site, the second-level virtual projectile "the virtual projectile No. 3" is controlled to attack the enemy. If one virtual projectile "the virtual projectile No. 4" remains on the site, the second-level virtual projectile "the virtual projectile No. 4" is controlled to attack the enemy.

Further, S1814 is performed, to determine whether the enemy is hit. The operation is ended if the enemy is not hit.

S1816 is performed if the enemy is hit, and corresponding damage is caused to knock back the enemy. S1818 continues to be performed to determine whether a second-level virtual projectile knocks back the enemy. If a second-level virtual projectile knocks back the enemy, S1820 is performed. The first skill returns to an ordinary state, a quantity of hit times is reset, and the operation ends.

Specifically, determining whether the enemy is hit is performed. If the enemy is hit, the enemy is knocked back, "the virtual projectile No. 1" causes least damage, "the virtual projectile No. 2" is added to "the virtual projectile No. 3", "the virtual projectile No. 3" is added to a previous virtual projectile, "the virtual projectile No. 4" causes most damage, and after "the virtual projectile No. 4" hits the enemy, the first skill returns to the ordinary state, and the quantities of hit times of all skills are reset. Up to now, a logic cycle of skill release is ended.

That is, in the foregoing implementation, as shown in FIG. 3, the player controls the current virtual role to release a first skill, the current virtual role throws an ink blob forward, the ink blob may fly by a distance of 7M (the farthest distance), and when the ink blob still misses the enemy after reaching the farthest distance, the ink blob disappears.

Then, as shown in FIG. 4, after the ink blob hits the enemy, a second-level virtual projectile (a virtual object 401) appears at a location at which the enemy is hit. In this case, the second-level virtual projectile is the first second-level virtual projectile appearing on the site. As shown in FIG. 5, the first second-level virtual projectile is a "first virtual object 505" (the virtual projectile No. 1), and the enemy is knocked back.

Subsequently, as shown in FIG. 5, each time the current virtual role hits an enemy by using a first skill, a second-level virtual projectile is displayed at the hit location, and the second second-level virtual projectile displayed on the site is a "second virtual object 506" (the virtual projectile No. 2), the third second-level virtual projectile is a "third virtual object 507" (the virtual projectile No. 3), and the fourth second-level virtual projectile is a "fourth virtual object 508" (the virtual projectile No. 4). In this embodiment, the virtual object is a virtual projectile.

After the four virtual projectiles "virtual projectile No. 1-virtual projectile No. 2-virtual projectile No. 3-virtual projectile No. 4" are accumulated on the site, a first skill changes to an enhanced first skill. The enhanced first skill is released, the current virtual role controls the second-level virtual projectile on the site to be transmitted forward, and a rule for transmitting the second-level virtual projectile is as follows: Each time a skill is released, a player controls a flight path direction of the second-level virtual projectile by using a direction key, one second virtual projectile is transmitted each time a skill is released, and as shown in FIG. 6, second virtual projectiles are transmitted in a sequence of "virtual projectile No. 1-virtual projectile No. 2-virtual projectile No. 3-virtual projectile No. 4" (that is, "first virtual object 605-second virtual object 606-third virtual object 607-fourth virtual object 608" in FIG. 6). After the enhanced first skill is released for four times, all second-level virtual projectiles on the site are completely transmitted, and the enhanced first skill returns to a first skill state.

Specifically, as shown in FIG. 6, the direction key is moved upward, the second-level virtual projectile is controlled to fly upward, and then the second-level virtual projectile is controlled to hit the enemy (as shown in FIG. 7), or after control duration exceeds particular time, the second-level virtual projectile disappears.

The enhanced first skill is released for the first time as shown in FIG. 6. A first virtual object 605, a second virtual object 606, a third virtual object 607, and a fourth virtual object 608 exist in FIG. 6. A current virtual role 603 controls a movement control 601 and a skill control 602 to attack a target virtual role 604 in response to a control operation of a player. The first virtual object 605 (the virtual projectile No. 1) hits the enemy.

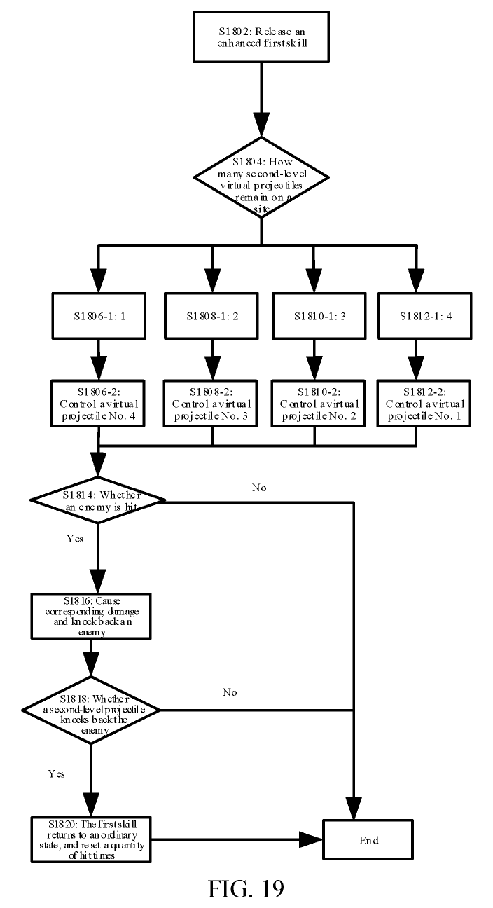

Then, in response to the user triggering the skill control 602 for the second time, the current virtual role 603 is controlled to release the enhanced first skill for the second time, and the interface is switched to be displayed as shown in FIG. 19. A first virtual object 1905, a second virtual object 1906, a third virtual object 1907, and a fourth virtual object 1908 exist in the figure. In response to a control operation of a player, a current virtual role 1903 controls a movement control 1901 and a skill control 1902 to attack a target virtual role 1904 to control a next second-level virtual projectile "the second virtual object 1906" to hit the enemy. In the figure, a virtual object that is not released is represented by a solid line, and the released virtual object is represented by a dashed line, or after control duration exceeds particular time, the second-level virtual projectile disappears.

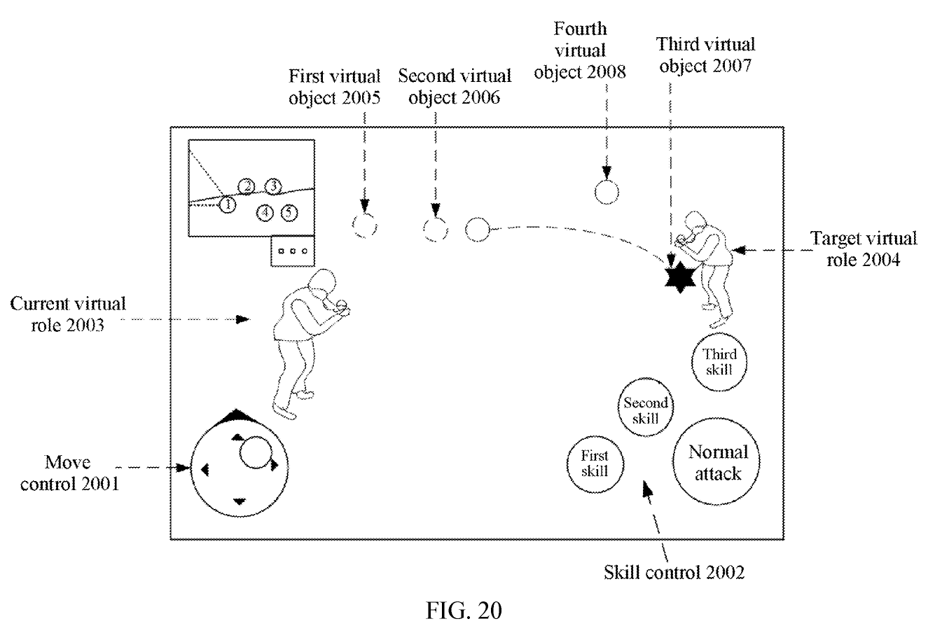

Then, in response to the user triggering the skill control 1902 for the third time, the current virtual role 1903 is controlled to release the enhanced first skill for the third time, and the interface is switched to be displayed as shown in FIG. 20. A next second-level virtual projectile "third virtual object 2007" is controlled to hit the enemy, or after control duration exceeds particular time, the second-level virtual projectile disappears. In FIG. 20, a first virtual object 2005, a second virtual object 2006, a third virtual object 2007, and a fourth virtual object 2008 exist. In response to a control operation of the player, a current virtual role 2003 controls a movement control 2001 and a skill control 2002 to attack a target virtual role 2004.

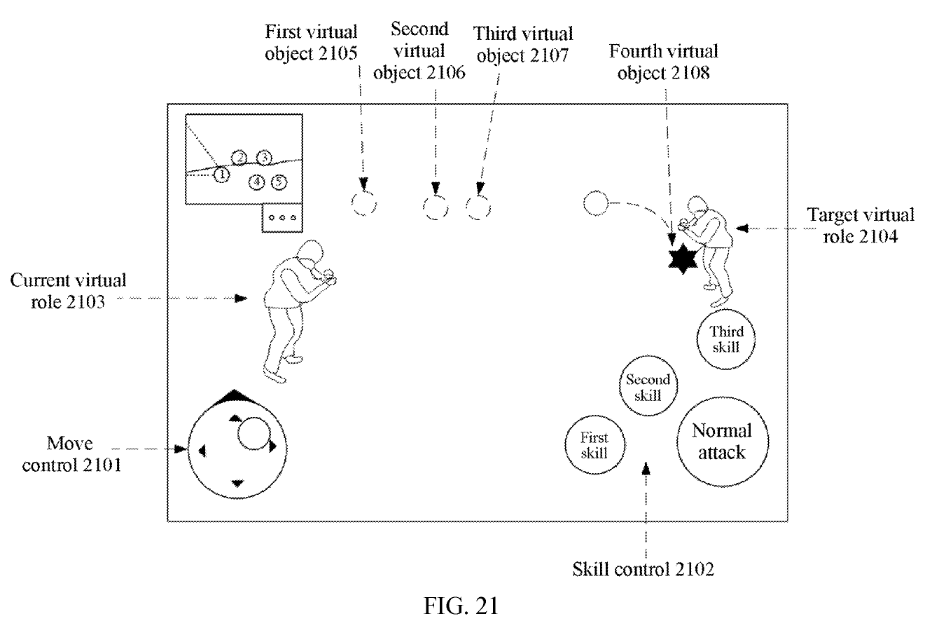

Then, in response to the user triggering the skill control 2002 for the fourth time, the current virtual role 2003 is controlled to release the enhanced first skill for the fourth time, and the interface is switched to be displayed as shown in FIG. 21. A next second-level virtual projectile "a fourth virtual object 2108" is controlled to hit the enemy. In the figure, a virtual object that is not released is represented by a solid line, and a virtual object that is released is represented by a dashed line. Alternatively, after control duration exceeds particular time, the second-level virtual projectile disappears. In FIG. 21, a first virtual object 2105, a second virtual object 2106, a third virtual object 2107, and a fourth virtual object 2108 exist. A current virtual role 2103 controls a movement control 2101 and a skill control 2102 to attack a target virtual role 2104 in response to a control operation of the player. In addition, each time the second-level virtual projectile hits the enemy, damage gradually increases. Specifically, damage values after the second-level virtual projectiles hit the enemy are: virtual projectile No. 4 > virtual projectile No. 3 > virtual projectile No. 2 > virtual projectile No. 1.

In another implementation, the ink blob projectile in the foregoing example may alternatively be a calligraphy word projectile. Specifically, as shown in FIG. 3, the player controls the current virtual role to release a first skill, the current virtual role throws an ink blob forward, the ink blob may fly by a distance of 7M, and when the ink blob still misses the enemy after reaching the farthest distance, the ink blob disappears.

Then, as shown in FIG. 11, after the ink blob hits the enemy, a virtual calligraphy word appears at the location at which the enemy is hit. In this case, if the virtual calligraphy word is the first virtual calligraphy word (a virtual object 1101) appearing on the site, the virtual object is a virtual calligraphy word "jing", and the enemy is knocked back.

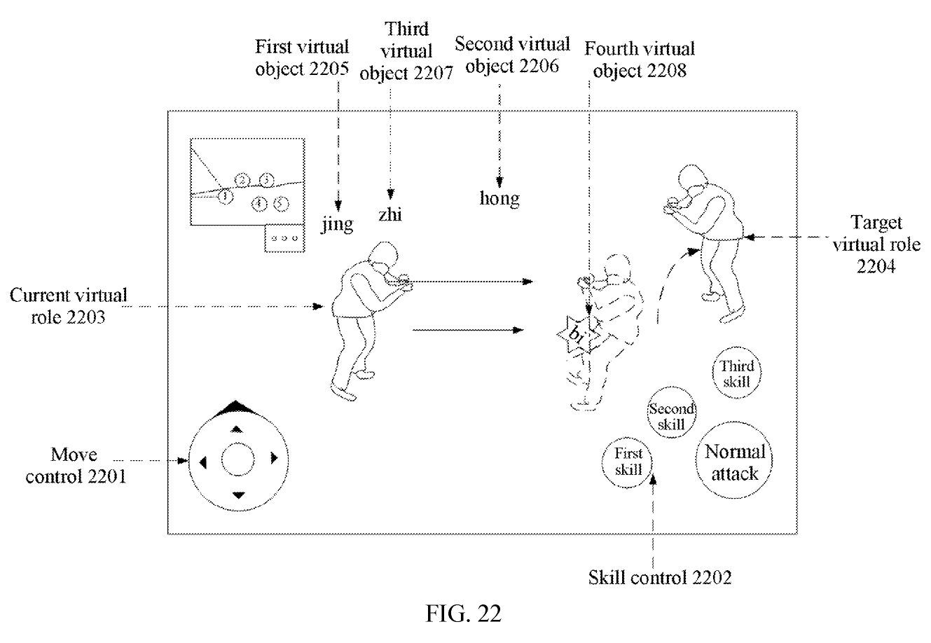

Subsequently, each time the current virtual role hits the enemy by using a first skill, one virtual object is displayed at a hit location, and the second virtual calligraphy word "hong", the third virtual calligraphy word "zhi", and the fourth virtual calligraphy word "bi" are displayed on the site. As shown in FIG. 22, a first virtual object 2205, a second virtual object 2206, a third virtual object 2207, and a fourth virtual object 2208 exist. A current virtual role 2203 controls, in response to a control operation of the player, a movement control 2201 and a skill control 2202 to attack a target virtual role 2204, and the fourth virtual object 2208 (the virtual calligraphy word "bi" hits the target virtual role 2204).

After the four words "jing-hong-zhi-bi" are accumulated on the site, the first skill becomes an enhanced first skill.

The enhanced first skill is released. The current virtual role controls the virtual calligraphy word on the site to be transmitted forward, and a rule of transmitting the virtual calligraphy word is as follows: Each time the skill is released, a player controls a flight path direction of one virtual calligraphy word by using a direction key (a specific control manner is shown in FIG. 13), and each time the skill is released, one virtual calligraphy word is transmitted, and is transmitted in an order of "jing-hong-zhi-bi". As shown in FIG. 13, a first virtual object 1305, a second virtual object 1306, a third virtual object 1307, and a fourth virtual object 1308 exist. A current virtual role 1303 controls, in response to a control operation of the player, a movement control 1301 and a skill control 1302 to attack a target virtual role 1304. After the enhanced first skill is released for four times, all virtual calligraphy words on the site are completely transmitted, and the enhanced first skill returns to a first skill state.

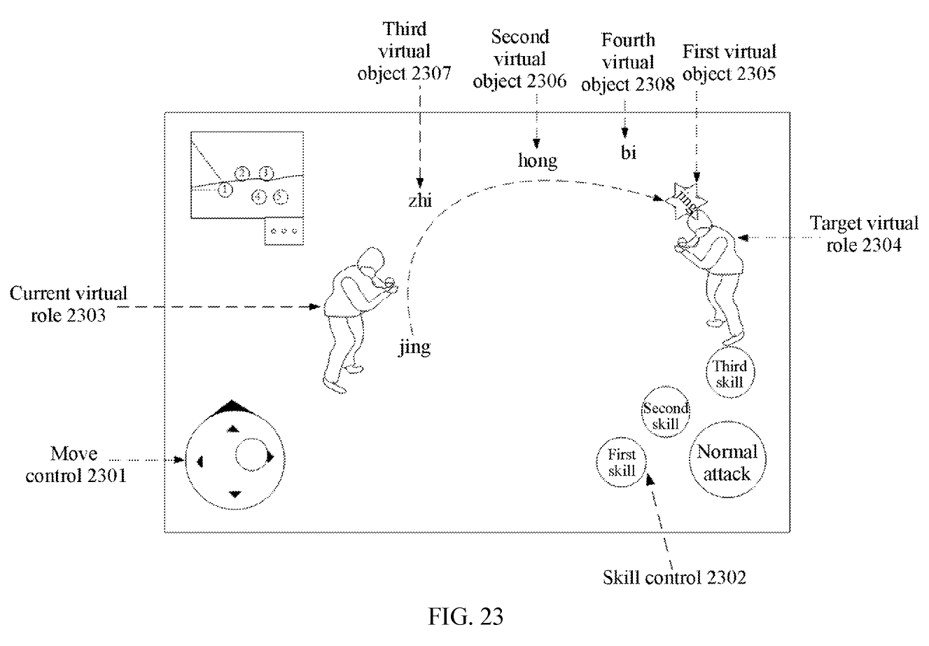

Specifically, as shown in FIG. 13, a direction key is moved upward, to control a virtual calligraphy word to fly upward; then, as shown in FIG. 14, the direction key is moved to the right on the flight way of the virtual calligraphy word, to control the virtual calligraphy word to fly to the right; and finally, as shown in FIG. 23, a movement control 2301 is controlled in real time, to control the virtual calligraphy word to hit the enemy. In FIG. 14, a first virtual object 1405, a second virtual object 1406, a third virtual object 1407, and a fourth virtual object 1408 exist. A current virtual role 1403 controls, in response to a control operation of the player, a movement control 1401 and a skill control 1402 to attack a target virtual role 1404.

In FIG. 23, a first virtual object 2305, a second virtual object 2306, a third virtual object 2307, and a fourth virtual object 2308 exist. A current virtual role 2303 controls, in response to a control operation of the player, a movement control 2301 and a skill control 2302 to attack a target virtual role 2304, or after control duration exceeds particular time, virtual calligraphy words disappear, and an enhanced first skill is released for the first time as shown in FIG. 23. Virtual calligraphy words "jing", "hong", "zhi", and "bi" exist in FIG. 23. The virtual calligraphy word "jing" (the first virtual object 2305) hit the enemy. The current virtual role 2303 controls, in response to a control operation of the player, a movement control 2301 and a skill control 2302 to hit the target virtual role 2304.

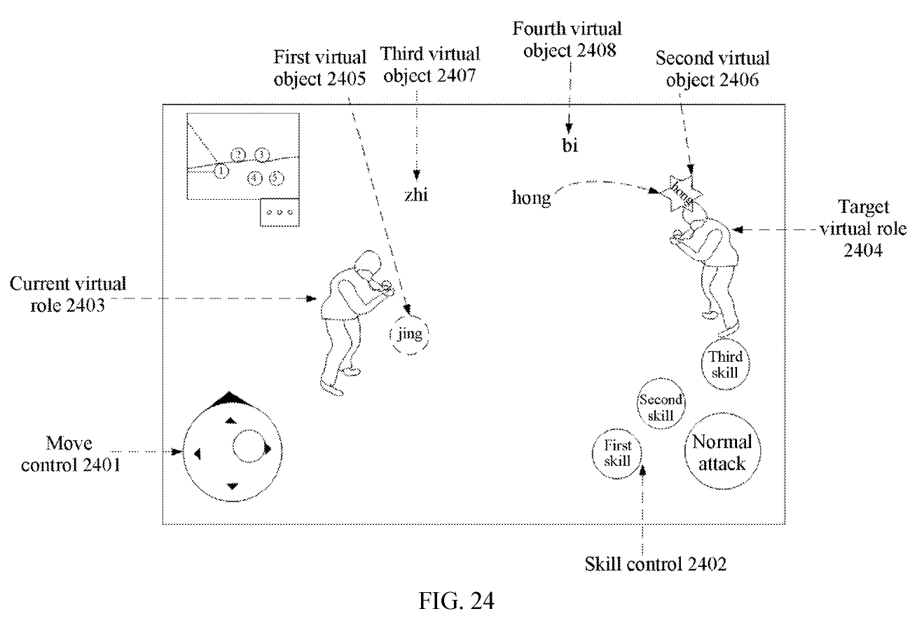

Then, in response to the user triggering the skill control 2302 for the second time, the current virtual role 2303 is controlled to release the enhanced first skill for the second time, and the interface is switched to be displayed as shown in FIG. 24 (the enhanced first skill is released for the second time, a next second virtual object 2406, that is, the virtual calligraphy word "hong" is controlled to hit the enemy, a virtual object that is not released in the figure is represented in a form of a calligraphy word, and a virtual calligraphy word that is released is displayed as being surrounded by a dashed line, or after control duration exceeds particular time, the virtual calligraphy word disappears). In FIG. 24, a first virtual object 2405, a second virtual object 2406, a third virtual object 2407, and a fourth virtual object 2408 exist. A current virtual role 2403 controls a movement control 2401 and a skill control 2402 to attack a target virtual role 2404 in response to a control operation of the player.

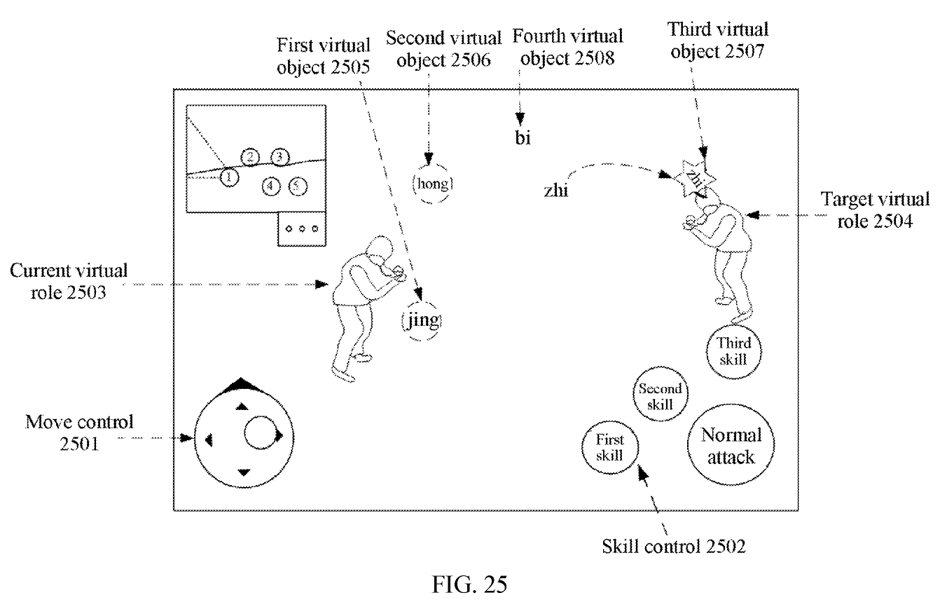

Then, in response to the user triggering the skill control 2402 for the third time, the current virtual role 2403 is controlled to release the enhanced first skill for the third time, and the interface is switched to be displayed as shown in FIG. 25 (the enhanced first skill is released for the third time, and then a next third virtual object 2507, that is, a virtual calligraphy word "zhi" is controlled to hit the enemy, or after control duration exceeds particular time, the virtual calligraphy word disappears). In FIG. 25, a first virtual object 2505, a second virtual object 2506, a third virtual object 2507, and a fourth virtual object 2508 exist. In response to a control operation of the player, the current virtual role 2503 controls a movement control 2501 and a skill control 2502 to attack a target virtual role 2504.

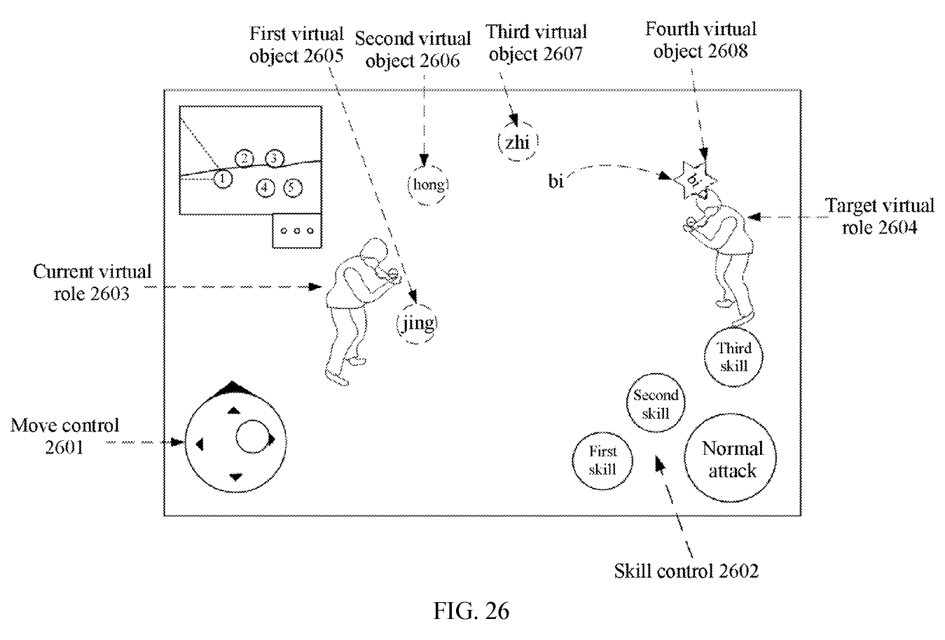

Then, in response to the user triggering the skill control 2502 for the fourth time, the current virtual role 2503 is controlled to release the enhanced first skill for the fourth time, and the interface is switched to be displayed as shown in FIG. 26 (the enhanced first skill is released for the fourth time, a next fourth virtual object 2608, that is, a virtual calligraphy word "bi" is controlled to hit the enemy, a virtual object that is not released is represented in a form of a calligraphy word, a virtual calligraphy word that is released is displayed as being surrounded by a dashed line, or after control duration exceeds particular time, the virtual calligraphy word disappears). In FIG. 26, a first virtual object 2605, a second virtual object 2606, a third virtual object 2607, and a fourth virtual object 2608 exist. In response to a control operation of the player, the current virtual role 2603 controls a movement control 2601 and a skill control 2602 to attack a target virtual role 2604. Each time the virtual calligraphy word hits the enemy, damage gradually increases. Specifically, damage values after the virtual calligraphy words hit the enemy are: bi > zhi > hong > jing.

In still another implementation, when the virtual scene includes a target virtual role (an enemy hero) located in a different role camp from the current virtual role and a reference virtual role (a friend hero) located in the same role camp as the current virtual role, the current virtual role battles against an enemy A (the target virtual role), the current virtual role releases a skill X, and the enemy A releases a skill Y, a virtual object (for example, a virtual balloon) is displayed at a cross point location when a skill track of the skill X and that of the skill Y cross. An interaction condition may be that when a quantity of displayed virtual balloons reaches 3, then the three virtual balloons sequentially become three virtual bombs. The skill control is selected to activate the virtual bombs to attack the target virtual role. Each virtual bomb attacks (explodes) a reference virtual role closest to the target virtual role or the enemy A. A damage value of the generated first virtual bomb is greater than a damage value of the second virtual bomb and is greater than a damage value of the third virtual bomb. This is merely an example herein and is not specifically limited.

According to the foregoing implementation of this application, after release of a virtual object in an ordinary first skill is completed and a condition for releasing an enhanced skill is met, the enhanced first skill is released to trigger the virtual object to perform an interactive operation with other virtual roles, and virtual objects in different orders in the enhanced first skill correspond to different damage values, so as to control the virtual object to cause different impact to other virtual roles, thereby implementing a new virtual object control method, and solving a technical problem that an existing virtual scene control mechanism has a single virtual object control method.

For simple descriptions, the foregoing method embodiments are stated as a series of action combinations. However, a person skilled in the art is to know that this application is not limited to the sequence of the described actions because according to this application, some operations may use another sequence or may be simultaneously performed. In addition, a person skilled in the art also needs to appreciate that all the implementations described in the present specification are examples of implementations, and the mentioned actions and modules are not necessarily mandatory to the present specification.

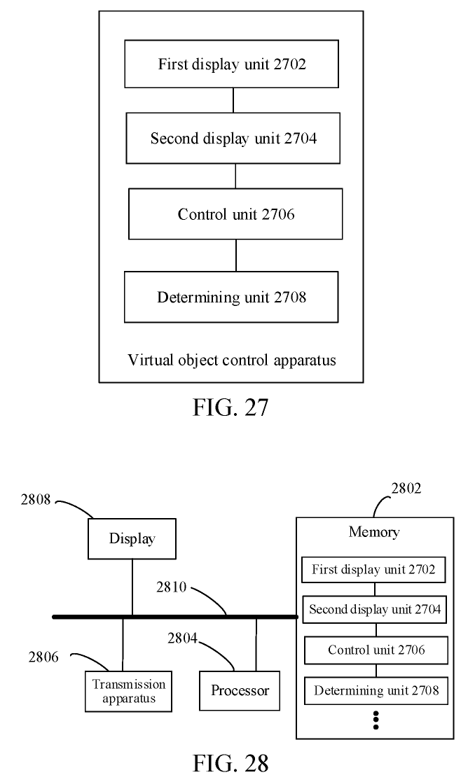

According to another aspect of embodiments of this application, a virtual object control apparatus for implementing the foregoing virtual object control method is further provided. As shown in FIG. 27, the apparatus includes:

a first display unit 2702, configured to display, in a virtual scene, a target virtual role that interacts with a current virtual role;

a second display unit 2704, configured to display, when an interactive operation triggered by the current virtual role meets an interaction condition, at least one virtual object at an interaction key location associated with the interactive operation in the virtual scene;

a control unit 2706, configured to: control, when a target virtual object of the at least one virtual object is in an activated state, the target virtual object in response to a control operation on the target virtual object to move according to a moving track indicated by the control operation; and

a determining unit 2708, configured to update a role status of the target virtual role in response to hitting the target virtual role by the target virtual object.

In a solution, the virtual object control apparatus further includes: a first determining unit, configured to: determine, when the interactive operation triggered by the current virtual role hits a first virtual role, that the interactive operation triggered by the current virtual role meets the interaction condition, and display the at least one virtual object at a role location of the first virtual role, where the interaction key location includes the role location of the first virtual role; configured to: determine, when the interactive operation triggered by the current virtual role defends against an attack operation triggered by a second virtual role, that the interactive operation triggered by the current virtual role meets the interaction condition, and display the at least one virtual object at a role location of the current virtual role, the interaction key location including the role location of the current virtual role; and configured to: determine, when a first operation track of the interactive operation triggered by the current virtual role intersects with a second operation track of an interactive operation triggered by a third virtual role, that the interactive operation triggered by the current virtual role meets the interaction condition, and display the at least one virtual object at a location corresponding to a track intersection point of the first operation track and the second operation track, the interaction key location including the location corresponding to the track intersection point.

In a solution, the first determining unit is further configured to: determine, when the interactive operation is a skill operation, a first object type of the virtual object according to a skill track display style corresponding to the skill operation, and display the virtual object of the first object type at the interaction key location; and determine, when the interactive operation is an attack operation, a second object type of the virtual object according to a role display style of the current virtual role, and display the virtual object of the second object type at the interaction key location.

In a solution, the first determining unit is further configured to: obtain, when the interactive operation is a skill operation, a skill track direction of the skill operation in response to a trigger operation on the skill operation; dynamically display a skill track of the skill operation according to the skill track direction by using the role location of the current virtual role as a start location; determine, when a track length of the displayed skill track is less than or equal to a preset distance and the displayed skill track reaches the role location of the first virtual role, that the interactive operation triggered by the current virtual role hits the first virtual role; and cancel displaying of the skill track when the track length of the displayed skill track is equal to the preset distance and the displayed skill track does not reach the role location of the first virtual role.

In a solution, the first determining unit is configured to cancel displaying of the skill track according to a target dynamic style.

In a solution, the first determining unit further includes: a first determining module, configured to: determine, when the first virtual role and the current virtual role are in the same role camp, that gain effect impact is caused to the first virtual role; and determine, when the first virtual role and the current virtual role are in different role camps, that negative effect impact is caused to the first virtual role.

In a solution, the first determining unit further includes: a first adjustment unit, configured to: adjust an active state parameter of the first virtual role from a first value to a second value, where it is determined that the first virtual role is in an active state in the virtual scene when the active state parameter of the first virtual role is greater than or equal to 0, the second value being less than the first value; adjust a moving state parameter of the first virtual role from a third value to a fourth value, the moving state parameter being configured for indicating a moving speed of the first virtual role in the virtual scene, and the fourth value being less than the third value; and update a knockback parameter for the first virtual role according to the interactive operation, and when the knockback parameter of the first virtual role meets a value condition, display that the first virtual role is flying in the virtual scene according to a preset flight track.

In a solution, the first display unit 2702 further includes: a second adjustment unit, configured to: configure, when an object quantity of the at least one virtual object is greater than or equal to a first quantity, the target virtual object determined from the at least one virtual object to be in the activated state in response to a trigger operation on a target skill control, the target skill control being configured for triggering the interactive operation of the current virtual role and configuring the activated state of the target virtual object; and determine, when the object quantity of the at least one virtual object is greater than or equal to the first quantity, to configure the target virtual object to be in the activated state in response to a selection operation on the target virtual object.

In a solution, the second adjustment unit further includes: a first adjustment module, configured to: determine, in response to a control operation on the target skill control in a first control state, that the current virtual role triggers the interactive operation, the target skill control in the first control state being configured for triggering the interactive operation of the current virtual role; and switch the target skill control from the first control state to a second control state when the object quantity of the virtual object is greater than or equal to the first quantity, the target skill control in the second control state being configured for configuring the activated state of the target virtual object.

In a solution, the second adjustment unit further includes: a switching module, configured to switch the target skill control from the second control state to the first control state when the object quantity of the at least one virtual object displayed in the virtual scene is less than or equal to a second quantity.

In a solution, the control unit 2706 further includes: a first control unit, configured to: determine, in response to a trigger operation on a direction control, that the control operation on the target virtual object is received; obtain a control direction determined according to the direction control, and control the target virtual object to move according to the control direction; and control the target virtual object to move according to the updated control direction when the control direction determined by the direction control is updated.

In a solution, the control unit 2706 further includes: a second control unit, configured to: display the target virtual object on a virtual ground in the virtual scene according to a first display style; display the target virtual object according to a second display style in response to a trigger operation on a direction control, the second display style being configured for indicating that the target virtual object is in the activated state; and obtain a control direction determined according to the direction control, and control, according to the control direction, the target virtual object displayed in the second display style to fly.

In a solution, the first display unit 2702 further includes: a first display module, configured to: obtain a display order of the at least one virtual object; determine, according to the display order, the first displayed virtual object in the at least one virtual object as the target virtual object; and configure the target virtual object to be in the activated state.

In a solution, the control unit 2706 further includes: a third control unit, configured to: sequentially determine, when an object quantity of remaining virtual objects in the virtual scene is greater than or equal to 1, the remaining virtual objects as the target virtual object according to the display order; control the target virtual object in response to a control operation on the target virtual object to move according to a moving track indicated by the control operation; and update a role status of the target virtual role in response to hitting the target virtual role by the target virtual object.

In a solution, the first unit further includes: a second display module, configured to: display status change information when control duration of the control operation on the target virtual object is less than preset duration and the target virtual object hits the target virtual role, the status change information being configured for indicating that the role status of the virtual role is updated; and cancel displaying of the target virtual object when the control duration of the control operation on the target virtual object is greater than or equal to the preset duration and the target virtual object has not hit the target virtual role.

In a solution, the first unit further includes: a third display module, configured to: obtain a damage value corresponding to the target virtual object when the role status includes a role active state indicated according to an active state parameter; and adjust an active state parameter of the target virtual role from a fifth value to a sixth value according to the damage value, the sixth value being less than the fifth value.

In a solution, the first unit further includes: a fourth display module, configured to: separately determine, when the at least one virtual object is sequentially determined as the target virtual object, a damage value corresponding to the target virtual object according to an object order respectively matching the target virtual object, a first damage value corresponding to a target virtual object having an earlier object order being less than or equal to a second damage value corresponding to a target virtual object having a later object order.

In some embodiments, in this embodiment, for embodiments to be implemented by the foregoing unit modules, refer to the foregoing method embodiments. Details are not described herein again.

According to still another aspect of embodiments of this application, an electronic device for implementing the foregoing virtual object control method is further provided. The electronic device may be a terminal device or a server as shown in FIG. 28. In this embodiment, that the electronic device is a terminal device is used as an example for description. As shown in FIG. 28, the electronic device includes a memory 2802 and a processor 2804. The memory 2802 has a computer program stored therein. The processor 2804 is configured to perform operations in any of the foregoing method embodiments through the computer program.

In this embodiment, the electronic device may be located in at least one network device of a plurality of network devices in a computer network.

In some embodiments, in this embodiment, the processor may be configured to perform, by using a computer program, the virtual object control method provided in the foregoing embodiment.

In some embodiments, a person of ordinary skill in the art may understand that the structure shown in FIG. 28 is merely an example. The electronic apparatus and the electronic device may alternatively be a terminal device such as a smartphone (such as an Android mobile phone or an iOS mobile phone), a tablet computer, a palmtop computer, a mobile internet device (MID), or a PAD. FIG. 28 does not constitute a limitation on a structure of the electronic apparatus and the electronic device. For example, the electronic apparatus and the electronic device may further include more or fewer components (for example, a network interface) than those shown in FIG. 28, or have a configuration different from that shown in FIG. 28.

The memory 2802 may be configured to store a software program and a module, such as a program instruction/module corresponding to the virtual object control method and apparatus in this embodiment of this application. The processor 2804 executes the software program and the module stored in the memory 2802, to perform various function applications and data processing. To be specific, the foregoing virtual object control method is implemented. The memory 2802 may include a high-speed random memory, and may also include a non-volatile memory, for example, one or more magnetic storage apparatuses, a flash memory, or another nonvolatile solid-state memory. In some embodiments, the memory 2802 may further include memories remotely disposed relative to the processor 2804, and the remote memories may be connected to a terminal through a network. Examples of the network include, but are not limited to, the Internet, an intranet, a local area network, a mobile communication network, and a combination thereof. The memory 2802 may be specifically, but is not limited to, configured to store information such as control information of various elements and virtual objects in a scene picture. As an example, as shown in FIG. 28, the memory 2802 may include, but is not limited to, the first display unit 2702, the second display unit 2704, the control unit 2706, and the determining unit 2708 in the foregoing virtual object control apparatus. Furthermore, the memory may further include, but is not limited to, another module unit in the virtual object control apparatus. Details are not described again in this example.

In one embodiment, a transmission apparatus 2806 is configured to receive or transmit data through a network. Specific instances of the foregoing network may include a wired network and a wireless network. In an example, the transmission apparatus 2806 includes a network interface controller (NIC). The NIC may be connected to another network device and a router by using a network cable, so as to communicate with the Internet or a local area network. In an example, the transmission apparatus 2806 is a radio frequency (RF) module, which is configured to communicate with the Internet in a wireless manner.

In addition, the electronic device further includes a display 2808, configured to display a virtual scene in an interface; and a connection bus 2810, configured to connect module components in the electronic device.

In other embodiments, the terminal device or the server may be a node in a distributed system, where the distributed system may be a blockchain system. The blockchain system may be a distributed system formed by a plurality of nodes connected in the form of network communication. A peer to peer (P2P) network may be formed between the nodes. Any form of a computing device, such as the server, the terminal, and another electronic device, may become a node in the blockchain system by joining the peer-to-peer network.

According to an aspect in this application, a computer program product is provided. The computer program product includes a computer program. The computer program includes program code configured for performing the method shown in the flowchart. In such an embodiment, the computer program may be downloaded and installed from the network through a communication part, and/or may be installed from a removable medium. When the computer program is executed by a central processing unit, the computer program executes functions provided in the embodiments of this application.

The sequence numbers of the foregoing embodiments of this application are merely for description purpose but do not imply the preference among the embodiments.

According to an aspect of this application, a non-transitory computer-readable storage medium is provided. A processor of a computer device reads computer instructions from the computer-readable storage medium. The processor executes the computer instructions, to cause the computer device to perform the foregoing virtual object control method.

In some embodiments, in this embodiment, the computer-readable storage medium may be set as a computer program stored for performing the virtual object control method provided in the foregoing embodiment.

In this embodiment, a person of ordinary skill in the art may understand that all or some of the operations of various methods in the foregoing embodiments may be implemented by a program instructing relevant hardware of a terminal device. The program may be stored in a non-transitory computer-readable storage medium. The storage medium may include: a flash drive, a read-only memory (ROM), a random access memory (RAM), a magnetic disk, an optical disc, or the like.

When the integrated unit in the foregoing embodiments is implemented in a form of a software functional unit and sold or used as an independent product, the integrated unit may be stored in the foregoing computer-readable storage medium. Based on such an understanding, the technical solutions of this application essentially, or a part contributing to the related art, or all or a part of the technical solution may be implemented in a form of a software product. The computer software product is stored in a storage medium and includes several instructions for instructing one or more computer devices (which may be a personal computer, a server, a network device, or the like) to perform all or some of operations of the methods in the embodiments of this application.

In the foregoing embodiments of this application, the descriptions of the embodiments have respective focuses. For a part that is not described in detail in an embodiment, refer to related descriptions in other embodiments.

In the several embodiments provided in this application, the disclosed client may be implemented in another manner. The described apparatus embodiment is merely an example. For example, the unit division is merely a logical function division and may be other division during actual implementation. For example, a plurality of units or components may be combined or integrated into another system, or some features may be ignored or not performed. In addition, the coupling, or direct coupling, or communication connection between the displayed or discussed components may be the indirect coupling or communication connection by means of some interfaces, units, or modules, and may be electrical or of other forms.

The units described as separate components may or may not be physically separated, and the components displayed as units may or may not be physical units, and may be located in one place or may be distributed over a plurality of network units. Some or all of the units may be selected according to actual needs to achieve the objectives of the solutions of the embodiments.

In addition, functional units in the embodiments of this application may be integrated into one processing unit, or each of the units may be physically separated, or two or more units may be integrated into one unit. The integrated unit may be implemented in a form of hardware, or may be implemented in a form of a software functional unit.

The foregoing descriptions are merely exemplary implementations of this application. Those of ordinary skill in the art may further make several improvements and modifications without departing from the principle of this application, and the improvements and modifications fall within the protection scope of this application.

What is claimed is:

1. A virtual object control method performed by an electronic device, the method comprising:
displaying a target virtual role that interacts with a current virtual role in a virtual scene;
displaying, when an interactive operation triggered by the current virtual role meets an interaction condition, at least one virtual object at an interaction key location associated with the interactive operation in the virtual scene;
controlling, when a target virtual object of the at least one virtual object is in an activated state, the target virtual object in response to a control operation on the target virtual object to move according to a moving track indicated by the control operation; and
updating a role status of the target virtual role in response to hitting the target virtual role by the target virtual object.

2. The method according to claim 1, wherein the displaying, when an interactive operation triggered by the current virtual role meets an interaction condition, at least one virtual object at an interaction key location associated with the interactive operation in the virtual scene comprises at least one of the following:
determining, when the interactive operation triggered by the current virtual role hits a first virtual role, that the interactive operation triggered by the current virtual role meets the interaction condition, and displaying the at least one virtual object at a role location of the first virtual role, the interaction key location comprising the role location of the first virtual role;
determining, when the interactive operation triggered by the current virtual role defends against an attack operation triggered by a second virtual role, that the interactive operation triggered by the current virtual role meets the interaction condition, and displaying the at least one virtual object at a role location of the current virtual role, the interaction key location comprising the role location of the current virtual role; and
determining, when a first operation track of the interactive operation triggered by the current virtual role intersects with a second operation track of an interactive operation triggered by a third virtual role, that the interactive operation triggered by the current virtual role meets the interaction condition, and displaying the at least one virtual object at a location corresponding to a track intersection point of the first operation track and the second operation track, the interaction key location comprising the location corresponding to the track intersection point.

3. The method according to claim 2, wherein the displaying at least one virtual object at an interaction key location associated with the interactive operation in the virtual scene comprises at least one of the following:
determining, when the interactive operation is a skill operation, a first object type of the virtual object according to a skill track display style corresponding to the skill operation, and displaying the virtual object of the first object type at the interaction key location; and
determining, when the interactive operation is an attack operation, a second object type of the virtual object according to a role display style of the current virtual role, and displaying the virtual object of the second object type at the interaction key location.

4. The method according to claim 2, wherein before the determining, when the interactive operation triggered by the current virtual role hits a first virtual role, that the interactive operation triggered by the current virtual role meets the interaction condition, and displaying the at least one virtual object at a role location of the first virtual role, the method further comprises:
obtaining, when the interactive operation is a skill operation, a skill track direction of the skill operation in response to a trigger operation on the skill operation;
dynamically displaying a skill track of the skill operation according to the skill track direction by using the role location of the current virtual role as a start location;
determining, when a track length of the displayed skill track is less than or equal to a preset distance and the displayed skill track reaches the role location of the first virtual role, that the interactive operation triggered by the current virtual role hits the first virtual role; and
canceling displaying of the skill track when the track length of the displayed skill track is equal to the preset distance and the displayed skill track does not reach the role location of the first virtual role.

5. The method according to claim 2, wherein the determining, when the interactive operation triggered by the current virtual role hits a first virtual role, that the interactive operation triggered by the current virtual role meets the interaction condition, and displaying the at least one virtual object at a role location of the first virtual role, the interaction key location comprising the role location of the first virtual role further comprises:
determining, when the first virtual role and the current virtual role are in a same role camp, that gain effect impact is caused to the first virtual role; and
determining, when the first virtual role and the current virtual role are in different role camps, that negative effect impact is caused to the first virtual role.

6. The method according to claim 1, wherein before the controlling, when a target virtual object of the at least one virtual object is in an activated state, the target virtual object in response to a control operation on the target virtual object to move according to a moving track indicated by the control operation, the method further comprises at least one of the following:
configuring, when an object quantity of the at least one virtual object is greater than or equal to a first quantity, the target virtual object determined from the at least one virtual object to be in the activated state in response to a trigger operation on a target skill control, the target skill control being configured for triggering the interactive operation of the current virtual role and configuring the activated state of the target virtual object; and
determining, when the object quantity of the at least one virtual object is greater than or equal to the first quantity, to configure the target virtual object to be in the activated state in response to a selection operation on the target virtual object.

7. The method according to claim 1, wherein the controlling the target virtual object in response to a control operation on the target virtual object to move according to a moving track indicated by the control operation comprises:
determining, in response to a trigger operation on a direction control, that the control operation on the target virtual object is received;
obtaining a control direction determined according to the direction control, and controlling the target virtual object to move according to the control direction; and
controlling the target virtual object to move according to the updated control direction when the control direction determined by the direction control is updated.

8. The method according to claim 1, wherein the controlling the target virtual object in response to a control operation on the target virtual object to move according to a moving track indicated by the control operation comprises:
displaying the target virtual object on a virtual ground in the virtual scene according to a first display style;
displaying the target virtual object according to a second display style in response to a trigger operation on a direction control, the second display style being configured for indicating that the target virtual object is in the activated state; and
obtaining a control direction determined according to the direction control, and controlling, according to the control direction, the target virtual object displayed in the second display style to fly.

9. The method according to claim 1, wherein the updating a role status of the target virtual role in response to hitting the target virtual role by the target virtual object comprises:
obtaining a damage value corresponding to the target virtual object when the role status comprises a role active state indicated according to an active state parameter; and
adjusting an active state parameter of the target virtual role from a fifth value to a sixth value according to the damage value, the sixth value being less than the fifth value.

10. The method according to claim 9, wherein the obtaining a damage value corresponding to the target virtual object when the role status comprises a role active state indicated according to an active state parameter comprises:
separately determining, when the at least one virtual object is sequentially determined as the target virtual object, a damage value corresponding to the target virtual object according to an object order respectively matching the target virtual object, a first damage value corresponding to a target virtual object having an earlier object order being less than or equal to a second damage value corresponding to a target virtual object having a later object order.

11. An electronic device, comprising a memory and a processor, the memory storing a computer program, and the computer program, when executed by the processor, causing the electronic device to perform a virtual object control method including:
displaying a target virtual role that interacts with a current virtual role in a virtual scene;
displaying, when an interactive operation triggered by the current virtual role meets an interaction condition, at least one virtual object at an interaction key location associated with the interactive operation in the virtual scene;
controlling, when a target virtual object of the at least one virtual object is in an activated state, the target virtual object in response to a control operation on the target virtual object to move according to a moving track indicated by the control operation; and
updating a role status of the target virtual role in response to hitting the target virtual role by the target virtual object.

12. The electronic device according to claim 11, wherein the displaying, when an interactive operation triggered by the current virtual role meets an interaction condition, at least one virtual object at an interaction key location associated with the interactive operation in the virtual scene comprises at least one of the following:
determining, when the interactive operation triggered by the current virtual role hits a first virtual role, that the interactive operation triggered by the current virtual role meets the interaction condition, and displaying the at least one virtual object at a role location of the first virtual role, the interaction key location comprising the role location of the first virtual role;
determining, when the interactive operation triggered by the current virtual role defends against an attack operation triggered by a second virtual role, that the interactive operation triggered by the current virtual role meets the interaction condition, and displaying the at least one virtual object at a role location of the current virtual role, the interaction key location comprising the role location of the current virtual role; and
determining, when a first operation track of the interactive operation triggered by the current virtual role intersects with a second operation track of an interactive operation triggered by a third virtual role, that the interactive operation triggered by the current virtual role meets the interaction condition, and displaying the at least one virtual object at a location corresponding to a track intersection point of the first operation track and the second operation track, the interaction key location comprising the location corresponding to the track intersection point.

13. The electronic device according to claim 12, wherein the displaying at least one virtual object at an interaction key location associated with the interactive operation in the virtual scene comprises at least one of the following:
determining, when the interactive operation is a skill operation, a first object type of the virtual object according to a skill track display style corresponding to the skill operation, and displaying the virtual object of the first object type at the interaction key location; and
determining, when the interactive operation is an attack operation, a second object type of the virtual object according to a role display style of the current virtual role, and displaying the virtual object of the second object type at the interaction key location.

14. The electronic device according to claim 12, wherein before the determining, when the interactive operation triggered by the current virtual role hits a first virtual role, that the interactive operation triggered by the current virtual role meets the interaction condition, and displaying the at least one virtual object at a role location of the first virtual role, the method further comprises:
obtaining, when the interactive operation is a skill operation, a skill track direction of the skill operation in response to a trigger operation on the skill operation;
dynamically displaying a skill track of the skill operation according to the skill track direction by using the role location of the current virtual role as a start location;
determining, when a track length of the displayed skill track is less than or equal to a preset distance and the displayed skill track reaches the role location of the first virtual role, that the interactive operation triggered by the current virtual role hits the first virtual role; and
canceling displaying of the skill track when the track length of the displayed skill track is equal to the preset distance and the displayed skill track does not reach the role location of the first virtual role.

15. The electronic device according to claim 12, wherein the determining, when the interactive operation triggered by the current virtual role hits a first virtual role, that the interactive operation triggered by the current virtual role meets the interaction condition, and displaying the at least one virtual object at a role location of the first virtual role, the interaction key location comprising the role location of the first virtual role further comprises:
determining, when the first virtual role and the current virtual role are in a same role camp, that gain effect impact is caused to the first virtual role; and
determining, when the first virtual role and the current virtual role are in different role camps, that negative effect impact is caused to the first virtual role.

16. The electronic device according to claim 11, wherein before the controlling, when a target virtual object of the at least one virtual object is in an activated state, the target virtual object in response to a control operation on the target virtual object to move according to a moving track indicated by the control operation, the method further comprises at least one of the following:
configuring, when an object quantity of the at least one virtual object is greater than or equal to a first quantity, the target virtual object determined from the at least one virtual object to be in the activated state in response to a trigger operation on a target skill control, the target skill control being configured for triggering the interactive operation of the current virtual role and configuring the activated state of the target virtual object; and
determining, when the object quantity of the at least one virtual object is greater than or equal to the first quantity, to configure the target virtual object to be in the activated state in response to a selection operation on the target virtual object.

17. The electronic device according to claim 11, wherein the controlling the target virtual object in response to a control operation on the target virtual object to move according to a moving track indicated by the control operation comprises:
determining, in response to a trigger operation on a direction control, that the control operation on the target virtual object is received;
obtaining a control direction determined according to the direction control, and controlling the target virtual object to move according to the control direction; and
controlling the target virtual object to move according to the updated control direction when the control direction determined by the direction control is updated.

18. The electronic device according to claim 11, wherein the controlling the target virtual object in response to a control operation on the target virtual object to move according to a moving track indicated by the control operation comprises:
displaying the target virtual object on a virtual ground in the virtual scene according to a first display style;
displaying the target virtual object according to a second display style in response to a trigger operation on a direction control, the second display style being configured for indicating that the target virtual object is in the activated state; and
obtaining a control direction determined according to the direction control, and controlling, according to the control direction, the target virtual object displayed in the second display style to fly.

19. The electronic device according to claim 11, wherein the updating a role status of the target virtual role in response to hitting the target virtual role by the target virtual object comprises:
obtaining a damage value corresponding to the target virtual object when the role status comprises a role active state indicated according to an active state parameter; and
adjusting an active state parameter of the target virtual role from a fifth value to a sixth value according to the damage value, the sixth value being less than the fifth value.

20. A non-transitory computer-readable storage medium, storing a computer program therein, the computer program, when executed by a processor of an electronic device, causing the electronic device to perform a virtual object control method including:
displaying a target virtual role that interacts with a current virtual role in a virtual scene;
displaying, when an interactive operation triggered by the current virtual role meets an interaction condition, at least one virtual object at an interaction key location associated with the interactive operation in the virtual scene;
controlling, when a target virtual object of the at least one virtual object is in an activated state, the target virtual object in response to a control operation on the target virtual object to move according to a moving track indicated by the control operation; and
updating a role status of the target virtual role in response to hitting the target virtual role by the target virtual object.
